(19) United States
(12) Patent Application Publication
(10) Pub. No.: US 2022/0278867 A1
(43) Pub. Date: Sep. 1, 2022

(54) METHOD AND APPARATUS FOR LINKING AND CONTROLLING IOT DEVICES BASED ON APP TO APP COMMUNICATION IN WIRELESS LAN SYSTEM IN SMART HOME ENVIRONMENT

(71) Applicant: LG Electronics Inc., Seoul (KR)

(72) Inventors: Byungjoo LEE, Seoul (KR); Jeonghwan KIM, Seoul (KR); Youngjun JO, Seoul (KR); Hangyu CHO, Seoul (KR)

(21) Appl. No.: 17/533,328

(22) Filed: Nov. 23, 2021

(30) Foreign Application Priority Data
Sep. 29, 2020 (KR) 10-2020-0127513

(51) Int. Cl. H04L 12/28; H04L 67/12; G16Y 40/30

(52) U.S. Cl. CPC H04L 12/2807; H04L 12/282; H04L 12/2838; H04L 67/12; G16Y 40/30; H04W 12/069

(57) ABSTRACT

Provided are a method and apparatus for controlling an IoT controlee through a connection between applications in a wireless LAN system in a smart home environment. Specifically, the controller generates a control command message based on a first application. The controller transmits the control command message to a controlee based on a connection between the first application and the second application. The first and second applications are installed on the controller. The controlee is controlled by the second application.

### CROSS-REFERENCE TO RELATED APPLICATIONS

Pursuant to 35 U.S.C. § 119 (a), this application claims the benefit of Korean Patent Application No. 10-2020-0127513, filed on Sep. 29, 2020, the contents of which are all hereby incorporated by reference herein in their entirety.

### BACKGROUND OF THE DISCLOSURE

### Field of the Disclosure

The present disclosure relates to a method of configuring an IoT device in a wireless LAN system in a smart home environment, and more particularly, to a method and apparatus for linking and controlling IoT devices based on App to App communication.

### Related Art

In recent years, Amazon, Apple, Google, and the Zigbee Alliance announced a new working group to drive the development and adoption of a new, royalty-free connectivity standard that increases compatibility between smart home products and embeds security into fundamental design principles. IKEA, Legrand, NXP Semiconductors, Resideo, Samsung SmartThings, Schneider Electric, Signify (Philips Hue), Silicon Labs, which form the board of directors of the Zigbee Alliance, Somfy, Wulian, and ThinQ (LG Electronics) will also join the working group to contribute to the project towards a common goal.

The goal of the Connected Home over IP project is to simplify development for manufacturers and increase compatibility for consumers. The project is based on the common belief that smart home devices need to ensure security, stability, and smooth usability. The project seeks to enable communication between smart home devices, mobile apps, and cloud services based on the Internet Protocol (IP), and to define a set of specific IP-based networking technologies for device authentication.

The industry working group adopts an open source approach to the development and application of new unified connectivity protocols. The project will utilize market-proven smart home technologies from companies such as Amazon, Apple, Google, and Zigbee Alliance. The decision to utilize these technologies is expected to accelerate the protocol development process and provide rapid benefits to manufacturers and consumers.

The project aims to simplify manufacturing of smart homes for device manufacturers, as well as devices compatible with voice recognition services such as Amazon's Alexa, Apple's Siri, and Google's Assistant. The upcoming protocol will complement existing technology, and the working group members encourage device manufacturers to continue to innovate based on existing technology.

The connected home over IP project encourages device manufacturers, silicon providers, and developers in the smart home industry to participate and contribute to development standards.

### SUMMARY

The present disclosure provides a method and apparatus for linking and controlling IoT devices based on App to App communication in a wireless LAN system in a smart home environment.

An example of the present disclosure provides a method of linking and controlling IoT devices based on App to App communication.

In an aspect, the present embodiment provides a method of linking and controlling, by an IoT controller, IoT devices through a connection between apps in a smart home environment. A controller to be described later may correspond to the IoT controller, and a controlee may correspond to the IoT device. The first and second applications to be described later may correspond to applications (Apps) of the same or different manufacturers installed in the controller.

A controller generates a control command message based on the first application.

The controller transmits the control command message to a controlee based on the connection between the first application and the second application.

The first and second applications are installed on the controller. The controlee is controlled by the second application. For example, it is assumed that the first application is made by manufacturer A and may control the device of manufacturer A, and the second application is made by manufacturer B and may control the device of manufacturer B. In this case, when the controlee corresponds to the device of manufacturer B, the controller may interwork the first and second applications so that the first application may control the controlee.

### BRIEF DESCRIPTION OF THE DRAWINGS

FIG. 1 illustrates an example of a transmitting apparatus and/or a receiving apparatus of the present disclosure.

FIG. 2 is a conceptual diagram illustrating a structure of a wireless local area network (WLAN).

FIG. 3 is a diagram for describing a general link setup process.

FIG. 4 is a diagram illustrating a Zigbee device type.

FIG. 5 is a diagram illustrating a Zigbee stack.

FIG. 6 is a diagram illustrating a modified example of a transmitting apparatus and/or a receiving apparatus of the present disclosure.

FIG. 7 is a diagram illustrating a connection form between a controller and a controlee in a smart home/IoT environment.

FIG. 8 is a diagram illustrating a conventional smart home/IoT connection structure.

FIG. 9 is a diagram illustrating an example in which App A controls device B through an App-to-App link.

FIG. 10 is a diagram illustrating operation steps for App-to-App connection.

FIG. 11 is a diagram illustrating an App discovery method through local loopback.

FIG. 12 is a diagram illustrating an operation when an App discovery fails.

FIG. 13 is a diagram illustrating an overview of OAuth 2.0 authentication for an App-to-App link.

FIG. 14 is a diagram illustrating an OAuth 2.0 authentication operation for an App-to-App link.

FIG. 15 is a diagram illustrating one-way authentication between certificate-based apps.

FIG. 16 is a diagram illustrating a mutual authentication operation of certificate-based App A and App B.

FIG. 17 is a diagram illustrating a secure session setup procedure for securing a communication channel between apps during an App-to-App link.

FIG. 18 is a diagram illustrating a device list discovery through App-to-App.

FIG. 19 is a diagram illustrating a status check of a specific device through App-to-App.

FIG. 20 is a diagram illustrating an example in which App A controls a device connected to App B.

FIG. 21 is a diagram illustrating an example in which App A transmits a command to a device connected to App B.

FIG. 22 is a diagram illustrating another example in which App A transmits a command to a device connected to App B.

FIG. 23 is a diagram illustrating an event reception setting and event reception process in an App-to-App connection.

FIG. 24 is a diagram illustrating an example of multi-App and App-to-App links.

FIG. 25 is a diagram illustrating an example in which device C is controlled from multiple apps.

FIG. 26 is a diagram illustrating a method of performing a service through an App-to-App link.

FIG. 27 is a flowchart of controlling a third-party device with the LG IoT App through an ATA interworking support module.

FIG. 28 is a flowchart illustrating an LG App connection with a third-party App.

FIG. 29 is a diagram illustrating a flowchart of a device notification procedure.

FIG. 30 is a flowchart of registering a callback for the device notification.

FIG. 31 is a flowchart illustrating a procedure for linking and controlling IoT devices based on App to App communication according to the present embodiment.

### DESCRIPTION OF EXEMPLARY EMBODIMENTS

In the present disclosure, “A or B” may mean “only A”, “only B” or “both A and B”. In other words, “A or B” in the present disclosure may be interpreted as “A and/or B”. For example, in the present disclosure, “A, B, or C” means “only A”, “only B”, “only C”, or “any and any combination of A, B, and C”.

A slash (/) or comma (comma) used in the present disclosure may mean “and/or”. For example, “A/B” may mean “and/or B”. Accordingly, “A/B” may mean “only A”, “only B”, or “both A and B”. For example, “A, B, C” may mean “A, B, or C”.

In the present disclosure, “at least one of A and B” may mean “only A” “only B” or “both A and B”. Also, in the present disclosure, the expression “at least one of A or B” or “at least one of A and/or B” means may be interpreted equivalently to the expression “at least one of A and B”.

Also, in the present disclosure, “at least one of A, B, and C” means “only A”, “only B”, “only C”, or “any combination of A, B and C”. Also, “at least one of A, B, or C” or “at least one of A, B and/or C” means may mean “at least one of A, B, and C”.

Also, parentheses used in the present disclosure may mean “for example”. Specifically, when displayed as “control information (EHT-Signal)”, “EHT-Signal” may be provided as an example of “control information”. In other words, the “control information” of the present disclosure is not limited to the “EHT-Signal”, and the “EHT-Signal” may be provided as an example of “control information”. Also, even when displayed as “control information (i.e., EHT-signal)”, “EHT-Signal” may be provided as an example of “control information”.

Technical features that are individually described within one drawing in the present disclosure may be implemented individually or may be implemented at the same time.

The following example of the present disclosure may be applied to various wireless communication systems. For example, the following example of the present disclosure may be applied to a wireless local area network (WLAN) system. For example, the present disclosure may be applied to IEEE 802.11a/g/n/ac standards or IEEE 802.11ax standards. In addition, the present disclosure may be applied to a newly provided EHT standard or IEEE 802.11be standard. In addition, an example of the present disclosure may be applied to the EHT standard or a new wireless LAN standard that enhances IEEE 802.11be. In addition, an example of the present disclosure may be applied to a mobile communication system. For example, it may be applied to a mobile communication system based on Long Term Evolution (LTE) based on the 3rd Generation Partnership Project (3GPP) standard and its evolution. In addition, an example of the present disclosure may be applied to a communication system of the 5G NR standard based on the 3GPP standard.

Hereinafter, in order to explain the technical characteristics of the present disclosure, the technical features to which the present disclosure may be applied will be described.

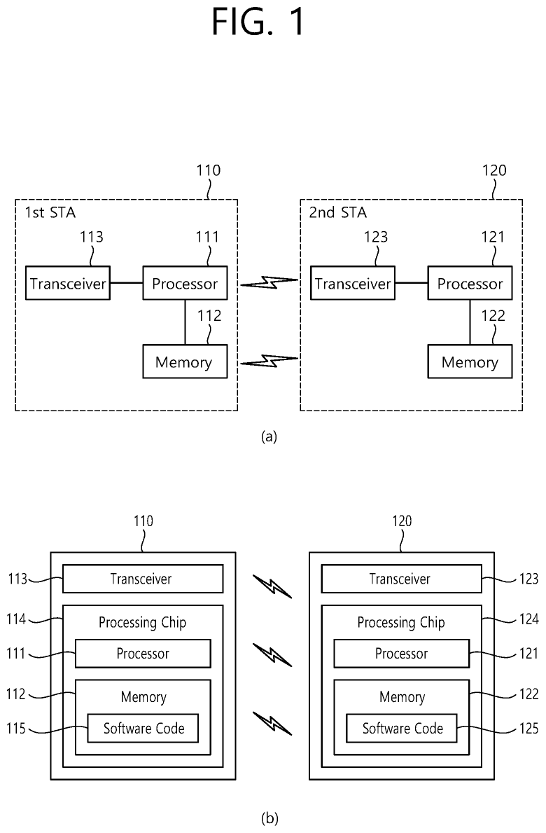

FIG. 1 illustrates an example of a transmitting apparatus and/or a receiving apparatus of the present disclosure.

The example of FIG. 1 may perform various technical features described below. FIG. 1 relates to at least one station (STA). For example, STAs 110 and 120 of the present disclosure may be called various names such as a mobile terminal, a wireless device, a wireless transmit/receive unit (WTRU), a user equipment (UE), a mobile station (MS), a mobile subscriber unit, or a simple user. The STAs 110 and 120 of the present disclosure may be called various names such as a network, a base station, a Node-B, an access point (AP), a repeater, a router, and a relay. The STAs 110 and 120 of the present disclosure may be called various names, such as a receiving apparatus, a transmitting apparatus, a receiving STA, a transmitting STA, a receiving device, and a transmitting device.

For example, the STAs 110 and 120 may perform an access point (AP) role or a non-AP role. That is, the STAs 110 and 120 of the present disclosure may perform functions of the AP and/or non-AP. In the present disclosure, the AP may also be indicated as an AP STA.

The STAs 110 and 120 of the present disclosure may support various communication standards other than the IEEE 802.11 standard. For example, communication standards (e.g., LTE, LTE-A, 5G NR standard) or the like according to the 3GPP standard may be supported. In addition, the STA of the present disclosure may be implemented in various devices such as a mobile phone, a vehicle, and a personal computer. In addition, the STA of the present disclosure may support communication for various communication services such as voice call, video call, data communication, and autonomous driving (self-driving, autonomous-driving).

In the present disclosure, the STAs 110 and 120 may include a medium access control (MAC) conforming to the IEEE 802.11 standard and a physical layer interface for a wireless medium.

The STAs 110 and 120 will be described based on sub-view, FIG. 1A as follows.

The first STA 110 may include a processor 111, a memory 112, and a transceiver 113. The illustrated processor, memory, and transceiver may each be implemented as separate chips, or at least two or more blocks/functions may be implemented through one chip.

The transceiver 113 of the first STA performs a signal transmission/reception operation. Specifically, IEEE 802.11 packets (e.g., IEEE 802.11a/b/g/n/ac/ax/be, etc.) may be transmitted/received.

For example, the first STA 110 may perform an intended operation of the AP. For example, the processor 111 of the AP may receive a signal through the transceiver 113, process the received signal, generate a transmission signal, and perform control for signal transmission. The memory 112 of the AP may store a signal (i.e., a received signal) received through the transceiver 113, and may store a signal (i.e., a transmission signal) to be transmitted through the transceiver.

For example, the second STA 120 may perform an intended operation of the non-AP STA. For example, the transceiver 123 of the non-AP performs a signal transmission/reception operation. Specifically, IEEE 802.11 packets (e.g., IEEE 802.11a/b/g/n/ac/ax/be, etc.) may be transmitted/received.

For example, the processor 121 of the non-AP STA may receive a signal through the transceiver 123, process the received signal, generate a transmission signal, and perform control for signal transmission. The memory 122 of the non-AP STA may store a signal (i.e., a received signal) received through the transceiver 123, and may store a signal to be transmitted through the transceiver (i.e., a transmission signal).

For example, an operation of a device denoted as an AP in the following specification may be performed by a first STA 110 or a second STA 120. For example, when the first STA 110 is the AP, the operation of the device indicated by the AP may be controlled by the processor 111 of the first STA 110, and the related signal may be may be transmitted or received through the transceiver 113 controlled by the processor 111 of the first STA 110. In addition, the control information related to the operation of the AP or the transmission/reception signal of the AP may be stored in the memory 112 of the first STA 110. In addition, when the second STA 110 is the AP, the operation of the device indicated by the AP is controlled by the processor 121 of the second STA 120 and controlled by the processor 121 of the second STA 120. In addition, the control information related to the operation of the AP or the transmission/reception signal of the AP may be stored in the memory 122 of the second STA 120.

For example, an operation of a device indicated as the non-AP (or user-STA) in the following specification may be performed by the first STA 110 or the second STA 120. For example, when the second STA 120 is the non-AP, the operation of the device indicated as the non-AP may be controlled by the processor 121 of the second STA 120, and the related signal may be transmitted or received via the transceiver 123 controlled by the processor 121 of the second STA 120. In addition, control information related to the operation of the non-AP or the AP transmission/reception signal may be stored in the memory 122 of the second STA 120. For example, when the first STA 110 is the non-AP, the operation of the device indicated as the non-AP may be controlled by the processor 110 of the first STA 110, and the related signal may be transmitted or received via the transceiver 113 controlled by the processor 111 of the first STA 110. In addition, control information related to the operation of the non-AP or the AP transmission/reception signal may be stored in the memory 112 of the first STA 110.

In the following specification (transmitting/receiving) STA, the first STA, the second STA, STA1, STA2, AP, a first AP, a second AP, AP1, AP2, a (transmitting/receiving) terminal, a (transmitting/receiving) device, a (transmission/reception) apparatus, a device called a network, etc. may refer to the STAs 110 and 120 of FIG. 1. For example, without (transmitting/receiving) STA without specific reference numerals, the first STA, the second STA, the STA1, the STA2, the AP, the first AP, the second AP, the AP1, the AP2, the (transmitting/receiving) terminal, the (transmitting/receiving) device, the (transmitting/receiving) apparatus, and the device indicated by the network may also refer to the STAs 110 and 120 of FIG. 1. For example, in the following example, an operation in which various STAs transmit and receive signals (e.g., PPPDUs) may be performed by the transceivers 113 and 123 of FIG. 1. In addition, in the following example, the operations of various STAs generating transmission/reception signals or performing data processing or calculation in advance for the transmission/reception signals may be performed by the processors 111 and 121 of FIG. 1. For example, an example of an operation of generating a transmission/reception signal or performing data processing or operation in advance for a transmission/reception signal may include 1) an operation of determining/acquiring/configuring/calculating/decoding/encoding bit information of a subfield (SIG, STF, LTF, Data) field included in the PPDU; 2) an operation of determining/configuring/obtaining a time resource or a frequency resource (e.g., a subcarrier resource) used for a subfield (SIG, STF, LTF, Data) field included in the PPDU; 3) Determine/configure/a specific sequence (e.g., pilot sequence, STF/LTF sequence, extra sequence applied to SIG) used for the subfield (SIG, STF, LTF, Data) field included in the PPDU, etc. recovery action, 4) a power control operation and/or a power saving operation applied to the STA; 5) operations related to determination/acquisition/configuration/operation/decoding/encoding of ACK signal. In addition, in the following example, various information (e.g., field/subfield/control field/parameter/power related information) used by various STAs for determination/acquisition/configuration/computation/decoding/encoding of transmission/reception signals is may be stored in the memories 112 and 122 of FIG. 1.

Regarding the device/STA of sub-view, FIG. 1A described above may be modified as illustrated in sub-view, FIG. 1B. Hereinafter, the STAs 110 and 120 of the present disclosure will be described based on sub-view, FIG. 1B.

For example, the transceivers 113 and 123 illustrated in FIG. 1B may perform the same function as the transceivers illustrated in FIG. 1A. For example, the processing chips 114 and 124 illustrated in FIG. 1B may include processors 111 and 121 and memories 112 and 122. The processors 111 and 121 and the memories 112 and 122 illustrated in FIG. 1B are the processors 111 and 121 and the memories 112 and 122 illustrated in FIG. 1A may perform the same function.

As described below, a mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, router, a relay, a receiving apparatus, a transmitting apparatus, a receiving STA, a transmitting STA, a receiving device, a transmitting device, a receiving apparatus, and/or a transmitting apparatus means the STAs 110 and 120 illustrated in the sub-views, FIGS. 1A and 1B, or may mean the processing chips 114 and 124 illustrated in FIG. 1B. That is, the technical features of the present disclosure may be performed on the STAs 110 and 120 illustrated in the sub-views, FIGS. 1A and 1B, and only in the processing chip 114 and 124 illustrated in the sub-view, FIG. 1B. For example, a technical feature in which a transmitting STA transmits a control signal is that the control signals generated by the processors 111 and 121 illustrated in the sub-views, FIGS. 1A and 1B may be understood as a technical feature transmitted through the transceivers 113 and 123 illustrated in the sub-views, FIGS. 1A and 1B. Alternatively, the technical feature in which the transmitting STA transmits the control signal may be understood as a technical feature in which the control signal to be transmitted to the transceivers 113 and 123 is generated from the processing chips 114 and 124 illustrated in the sub-view, FIG. 1B.

For example, the technical feature in which the receiving STA receives the control signal may be understood as the technical feature in which the control signal is received by the transceivers 113 and 123 illustrated in the sub-view, FIG. 1A. Alternatively, the technical feature in which the receiving STA receives the control signal may be understood as the technical feature that the control signal received by the transceivers 113 and 123 illustrated in the sub-view, FIG. 1A is acquired by the processors 111 and 121 illustrated in the sub-view, FIG. 1A. Alternatively, the technical feature in which the receiving STA receives the control signal may be understood as the technical feature that the control signals received by the transceivers 113 and 123 illustrated in the sub-view, FIG. 1B are acquired by the processing chips 114 and 124 illustrated in the sub-view, FIG. 1B.

Referring to the sub-view, FIG. 1B, software codes 115 and 125 may be included in the memories 112 and 122. The software codes 115 and 125 may include instructions for controlling the operations of the processors 111 and 121. The software codes 115 and 125 may be included in a variety of programming languages.

The processors 111 and 121 or the processing chips 114 and 124 illustrated in FIG. 1 may include an application-specific integrated circuit (ASIC), other chipsets, logic circuits, and/or data processing devices. The processor may be an application processor (AP). For example, the processors 111 and 121 or the processing chips 114 and 124 illustrated in FIG. 1 may include at least one of a digital signal processor (DSP), a central processing unit (CPU), a graphics processing unit (GPU), and a modem (modulator and demodulator). For example, the processors 111 and 121 or the processing chips 114 and 124 illustrated in FIG. 1 are a SNAPDRAGON′ series processor manufactured by Qualcomm®, EXYNOS™ series processor manufactured by Samsung®, A series processor manufactured by Apple®, HELIO™ series processor manufactured by MediaTek®, an ATOM™ series processor manufactured by INTEL®, or a processor enhancing them.

In the present disclosure, an uplink may mean a link for communication from a non-AP STA to an AP STA, and an uplink PPDU/packet/signal may be transmitted through the uplink. In addition, in the present disclosure, the downlink may mean a link for communication from the AP STA to the non-AP STA, and a downlink PPDU/packet/signal or the like may be transmitted through the downlink.

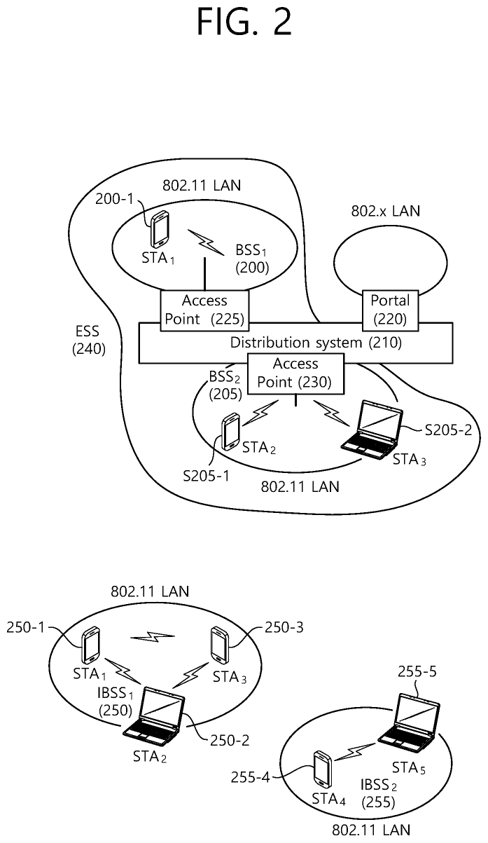

FIG. 2 is a conceptual diagram illustrating a structure of a wireless local area network (WLAN).

An upper part of FIG. 2 illustrates a structure of an infrastructure basic service set (BSS) of the Institute of Electrical and Electronic Engineers (IEEE) 802.11.

Referring to the upper part of FIG. 2, a wireless LAN system may include one or more infrastructure BSSs 200 and 205 (hereinafter, BSSs). The BSSs 200 and 205 are a set of APs and STAs, such as an access point (AP) 225 and a station 200-1 (STA1) that may communicate with each other through successful synchronization, and are not a concept indicating a specific area. The BSS 205 may include one or more STAs 205-1 and 205-2 connectable to one AP 230.

The BSS may include at least one STA, APs 225 and 230 that provide a distribution service, and a distribution system DS 210 that connects a plurality of APs.

The distributed system 210 may implement an extended service set (ESS) 240 that is an extended service set by connecting several BSSs 200 and 205. The ESS 240 may be used as a term indicating one network in which one or several APs are connected through the distributed system 210. The APs included in one ESS 240 may have the same service set identification (SSID).

The portal 220 may serve as a bridge connecting a wireless LAN network (IEEE 802.11) and another network (e.g., 802.X).

In the BSS as illustrated in the upper part of FIG. 2, a network between the APs 225 and 230 and a network between the APs 225 and 230 and the STAs 200-1, 205-1 and 205-2 may be implemented. However, it may also be possible to establish a network and perform communication between STAs without the APs 225 and 230. A network that establishes a network and performs communication even between STAs without the APs 225 and 230 is defined as an ad-hoc network or an independent basic service set (IBSS).

The lower part of FIG. 2 is a conceptual diagram illustrating the IBSS.

Referring to the lower part of FIG. 2, the IBSS is a BSS operating in an ad-hoc mode. Since the IBSS does not include an AP, there is no centralized management entity that performs a centralized management function. That is, in the IBSS, the STAs 250-1, 250-2, 250-3, 255-4, and 255-5 are managed in a distributed manner. In IBSS, all STAs 250-1, 250-2, 250-3, 255-4, and 255-5 may be mobile STAs, and cannot access a distributed system, and therefore, forms a self-contained network.

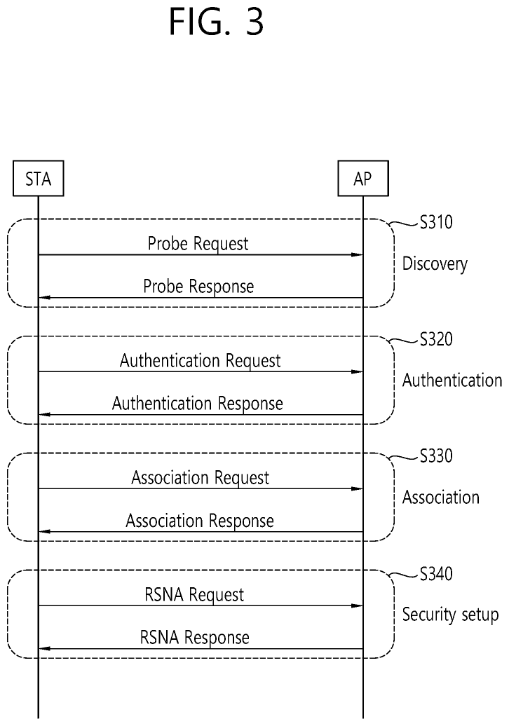

FIG. 3 is a diagram for describing a general link setup process.

In the illustrated step S310, the STA may perform a network discovery operation.

The network discovery operation may include a scanning operation of the STA. That is, in order for the STA to access the network, there is a need to find a network that may participate in the wireless network. The STA needs to identify a compatible network before participating in the wireless network. The process of identifying a network existing in a specific area is called scanning. The scanning method includes active scanning and passive scanning.

FIG. 3 exemplarily illustrates a network discovery operation including an active scanning process. In the active scanning, an STA performing scanning transmits a probe request frame to discover which APs exist therearound while moving channels, and waits for a response to the probe request frame. A responder transmits, as a response to the probe request frame, a probe response frame to the STA that has transmitted the probe request frame. Here, the responder may be the STA that last transmitted a beacon frame in the BSS of the channel being scanned. In the BSS, since the AP transmits a beacon frame, the AP becomes the responder. In the IBSS, the STAs in the IBSS alternately transmit the beacon frame, so the responder is not constant. For example, an STA that transmits a probe request frame on channel 1 and receives a probe response frame on channel 1 may store BSS-related information included in the received probe response frame and channel, and may move to the next channel (e.g., channel 2) and perform scanning (i.e., transmit/receive probe request/response on channel 2) in the same manner.

Although not illustrated in the example of FIG. 3, the scanning operation may be performed in a passive scanning manner. The STA performing the scanning based on the passive scanning may wait for a beacon frame while moving channels. The beacon frame is one of the management frames in IEEE 802.11, and is periodically transmitted to notify the existence of a wireless network, and is periodically transmitted so that the STA performing the scanning may find the wireless network and participate in the wireless network. In the BSS, the AP plays a role of periodically transmitting a beacon frame, and in the IBSS, the STAs in the IBSS rotate and transmit the beacon frame. When the STA performing the scanning receives the beacon frame, it stores information on the BSS included in the beacon frame and records the beacon frame information in each channel while moving to another channel. The STA receiving the beacon frame may store BSS-related information included in the received beacon frame, move to the next channel, and perform scanning on the next channel in the same manner.

The STA discovering the network may perform an authentication process through step S320. This authentication process may be referred to as a first authentication process in order to clearly distinguish the first authentication process from the security setup operation of step S340 to be described later. The authentication process of S320 may include a process in which the STA transmits an authentication request frame to the AP, and in response thereto, the AP transmits an authentication response frame to the STA. An authentication frame used for an authentication request/response corresponds to a management frame.

The authentication frame may include an authentication algorithm number, an authentication transaction sequence number, a status code, a challenge text, a robust security network (RSN), and a finite cyclic group, etc.

The STA may transmit an authentication request frame to the AP. The AP may determine whether to allow authentication for the corresponding STA based on information included in the received authentication request frame. The AP may provide the result of the authentication process to the STA through the authentication response frame.

The successfully authenticated STA may perform a connection process based on step S330. The connection process includes a process in which the STA transmits an association request frame to the AP, and in response, the AP transmits an association response frame to the STA. For example, the association request frame includes information related to various capabilities, and information related to a beacon listening interval, a service set identifier (SSID), supported rates, supported channels, RSN, mobility domain, supported operating classes, a traffic indication map (TIM) broadcast request, interworking service capability, and the like. For example, the association response frame may include information related to various capabilities, and information related to a status code, an association ID (AID), a support rate, an enhanced distributed channel access (EDCA) parameter set, a received channel power indicator (RCPI), a received signal to noise indicator (RSNI), a mobility domain, a timeout interval (association comeback time), an overlapping BSS scan parameter, a TIM broadcast response, a QoS map, and the like.

Thereafter, in step S340, the STA may perform a security setup process. The security setup process in step S340 may include, for example, a process of private key setup through 4-way handshaking through an extensible authentication protocol over LAN (EAPOL) frame.

1. Zigbee and Connected Home Over IP (CHIP)

<Necessity of Zigbee>

There are currently standards for data such as voice, PC LANs, and video, but no wireless network standards to meet special needs of sensors or control devices. The sensors and control devices do not require a high frequency bandwidth, but require low latency and low energy consumption for long-term battery life and a wide array of devices.

Today, various wireless communication systems that do not require high data rates and operate with low cost and low power consumption are being produced.

Products produced in this way are manufactured without standards, and in the end, these past products cause compatibility problems with each product, and also problems with compatibility with new technologies.

<Introduction of Zigbee>

ZigBee is a high-level communication protocol that uses a small, low-power digital radio based on IEEE 802.15.4-2003. IEEE 802.15.4-2003 is a standard for short-range personal wireless communication networks such as lamps, electronic meters, and consumer electronic products using short-range radio frequencies. ZigBee is mainly used in radio frequency (RF) applications that require low data rates, low battery consumption, and network safety.

<Zigbee Features>

1) Low power consumption, simple implementation

2) Used for several months or years on one battery charge

3) Having active mode (receive, transmit), sleep mode.

4) Device, installation, maintenance, etc. are all possible at a relatively low cost

5) Safety (Security)

6) Reliability

7) Flexibility

8) Very small protocol stack

9) Interoperable and used anywhere

10) High node density per network (ZigBee's use of IEEE 802.15.4 makes it possible to handle many devices in the network. This feature enables control of a vast array of sensors and networks)

11) Simple protocol, internationally implemented (ZigBee protocol stack code size is only about a quarter of that of Bluetooth or 802.11)

<Use Field of Zigbee>

Zigbee is currently used in industrial control, embedded sensors, medical data collection, fire and theft, building automation, and home automation.

1) Smart Energy

Smart energy provides utility/energy service providers with a secure and easy-to-use home wireless network to manage energy. The smart energy enables utility/energy service providers or their customers to directly control thermostats or other associated devices.

2) Home Entertainment and Control

A smart power supply, an advanced temperature control system, safety and security, movies, and music

3) Home Recognition System

A water temperature sensor, a power sensor, energy monitoring, fire and theft monitoring, smart devices, and connection sensors

4) Mobile Service

Mobile payment, mobile monitoring and control, mobile security and access control, mobile healthcare, and remote support

5) Commercial Building

Energy monitoring, air conditioning equipment, lighting, and access control

6) Industrial Plant

Process control, material management, environmental management, energy management, industrial device control, and M2M communication

<Zigbee Device Type>

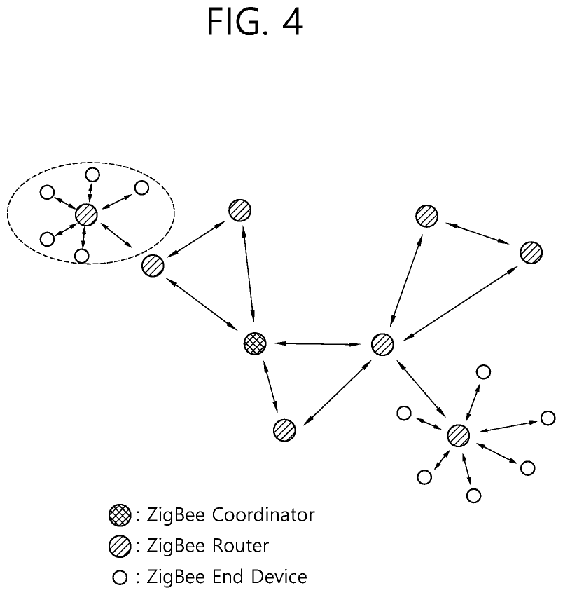

FIG. 4 is a diagram illustrating a Zigbee device type.

There are three types of Zigbee devices as illustrated in FIG. 4.

1) Zigbee Coordinator

The Zigbee coordinator forms a network with the most important device and connects the network with other networks. Each network has only one coordinator. The Zigbee coordinator may store information on the network and also serves as a trust center or storage for security keys.

2) Zigbee Router

A router may not only function as an application, but also function as a writer that may transmit data from other devices.

3) Zigbee End Device

The ZigBee end device includes the ability to communicate with the parent node.

This relationship may allow a node to wait a long time, which may further extend the battery life.

<Zigbee Features>

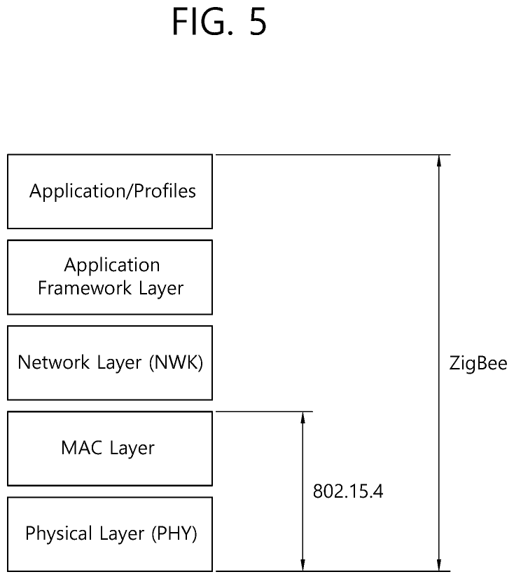

FIG. 5 illustrates a Zigbee stack.

The Zigbee stack is simpler than many other protocol stacks, and the size of the Zigbee stack code is small compared to other protocols. The MAC and PHY are defined by the IEEE 802.15.4 standard. The network and application layers are defined by the Zigbee Alliance and the actual application provided by the device designer.

802.15.4 is a simple packet data protocol for lightweight wireless networks. 802.15.4 is intended to monitor and control applications where battery life is critical. 802.15.4 is a source of ZigBee's excellent battery life.

802.15.4 is applicable to both IEEE long/short addressing. Short addressing is used for network management where a network ID is temporarily determined. This makes it less costly, but still allows use of over 65,000 network nodes.

In addition, 802.15.4 enables reliable data transmission and beacon management.

The network layer ensures proper operation of the MAC layer and provides an interface to the application layer. The network layer supports star, tree, and mesh topologies. The network layer is where networks are initiated, joined, destroyed, and discovered.

The network layer is responsible for routing and security.

The application framework is an execution environment in which application objects may exchange data. The application object is defined by the producer of the Zigbee device. As defined by Zigbee, the application object is located at the top of the application layer and is determined by the device manufacturer. The application object actually builds the application. This could be a light bulb, a light switch, an LED, an I/O line, and so on.

Looking at home appliances that are released these days, a modifier ‘smart’ is almost inevitably attached to the home appliances. It is difficult to find products that do not apply ‘smart’, such as smart TVs, smart refrigerators, smart air conditioners, and smart washing machines. These smart products are equipped with wired and wireless networks, communicate closely with each other, and implement various convenient functions based on Internet of Things (IoT) technology. When including various sensors with IoT technology, such as temperature and humidity sensors, door sensors, motion sensors, and IP cameras, it is possible to use more precise and diverse automation functions.

When a number of these smart products are gathered and applied to a single house, a ‘smart home’ is created. If users live in such a house, they may use various automation or remote functions, such as automatically turning on lights or air conditioners when users come home from work outside, and automatically playing appropriate music depending on the weather that day. Other similar concepts include “smart building”, “smart factory”, and the like.

However, there are side effects caused by the proliferation of smart products and products of various specifications. It is just a compatibility issue. In the IoT technology, communication and links between devices is the key, but since each device uses a different IoT platform, when they do not interwork with each other, the usability is greatly reduced.

For example, when the speaker is a product based on the ‘Apple HomePod’ platform, but the TV is only compatible with the ‘Samsung SmartThings’ platform, users may not be able to use the function to turn on the TV or switch channels through voice commands. Of course, recently, a single product may simultaneously support two or more IoT platforms. Or, there is a way to decorate a smart environment by purchasing all products based on the same platform. Even so, it is inconvenient to have to closely examine compatibility every time users purchase a product.

However, users probably do not need to worry about this in the future. This is because major IoT-related companies have gathered and announced a standard specification that allows all devices to be compatible without being platform dependent. Last May, the connectivity standards alliance (CSA) standards association introduced an IoT standard protocol called “Matter”. The Matter standard known as project connected home over IP (CHIP) in the past has been supported by Amazon, Google, Signify (Philips Hue), SmartThings, and other major players in the smart home market.

There are dozens of companies participating in the Matter standard enactment or announcing cooperation, including Samsung Electronics, Google, Amazon, Apple, Tuya, Huawei, and Schneider Electric. These companies are global companies with a high market share in the IoT market. When the matter standards become widespread, all smart devices will now work seamlessly, regardless of manufacturer or platform.

The Matter is an IP-based protocol that may run on existing network technologies such as Wi-Fi, Ethernet, and thread. The federation of said Matter devices could be easily set up using Bluetooth low energy (BLE). Because the smart home devices may inform each other of their identity and possible operations, users do not need to do complicated configuration.

In particular, Matter's feature called ‘multi-admin’ allows products from various ecosystems, such as Apple HomeKit and Amazon Alexa, to work together without the complicated work of end users. Multi-admin may also set up layers of control to help different family members connect to smart appliances in the home with different levels of control.

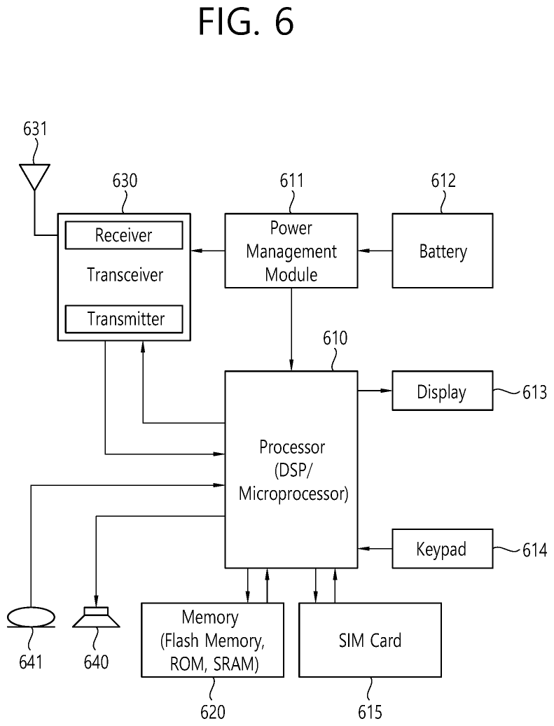

FIG. 6 illustrates a modified example of a transmitting device and/or receiving device of the present specification.

Each device/STA of the sub-figure (a)/(b) of FIG. 1 may be modified as shown in FIG. 6. A transceiver 630 of FIG. 6 may be identical to the transceivers 113 and 123 of FIG. 1. The transceiver 630 of FIG. 6 may include a receiver and a transmitter.

A processor 610 of FIG. 6 may be identical to the processors 111 and 121 of FIG. 1. Alternatively, the processor 610 of FIG. 6 may be identical to the processing chips 114 and 124 of FIG. 1.

A memory 620 of FIG. 6 may be identical to the memories 112 and 122 of FIG. 1. Alternatively, the memory 620 of FIG. 6 may be a separate external memory different from the memories 112 and 122 of FIG. 1.

Referring to FIG. 6, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 6, a speaker 640 may output a result related to a sound processed by the processor 610. A microphone 641 may receive an input related to a sound to be used by the processor 610.

2. Examples Applicable to the Present Disclosure

The present disclosure provides a method of controlling and monitoring IoT (Internet of Things) devices in a smart home environment. In particular, proposed is a method of allowing another control application to control a device that has already obtained control right (onboarding) through a link between IoT control applications (Apps) between different manufacturers or platform companies. To this end, the IoT control applications are discovered for each other, the link request for control, and the authentication method of the app are performed. Also, even when the IoT devices, which are the controlee, are not located close to each other, a method of remote access through communication between apps and a method of communication between multiple apps will be described.

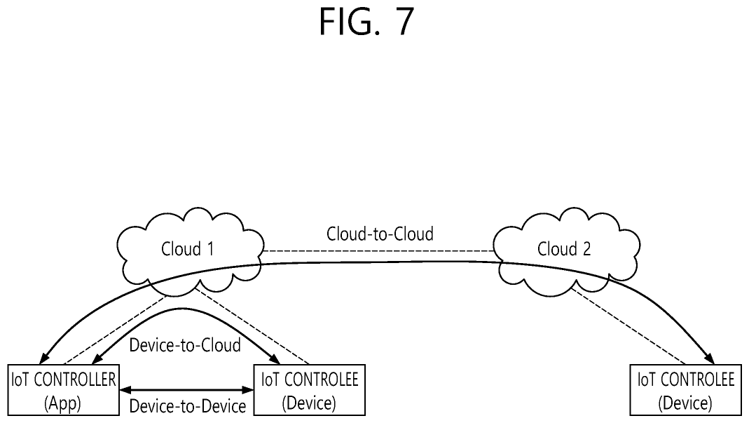

FIG. 7 is a diagram illustrating a connection form between a controller and a controlee in a smart home/IoT environment.

In the current smart home/IoT environment, depending on the connection method, the control device (App) and the IoT device interwork by direct connection between devices, connection through clouds, and connection between the clouds. In particular, when manufacturers of IoT devices and apps are different, standard and non-standard methods are used to interwork them.

1) Device-to-Device Connection

When the controller App and the controlee IoT Device are located close to one local network, it is a method of direct control between devices (see FIG. 7). This is a method of linking between apps and devices without cloud intervention. Representative technologies such as Apple Homekit, OCF, and AllJoyn are available.

2) Device-to-Cloud Connection

This is a method of transmitting the controller App and the controlee IoT Device through the cloud for device control and status monitoring in the status of being connected to the same cloud (see FIG. 7). In general, this method is used when the App, cloud, and device are all products of the same company. Representative technologies are to connect the App and device to the cloud of each company, such as LG ThinQ and Samsung SmartThings, and control the device using the App.

3) Cloud-to-Cloud Connection

When the cloud to which the controller App is connected and the cloud to which the IoT device is connected are different, the control and monitoring commands of the controller App are transmitted from Cloud 1 to Cloud 2 through a link between the two clouds and transmitted to the device (see FIG. 7). This is mainly a connection method used when the app manufacturer and the IoT device manufacturer are different, and is a connection method such as Google Home and Amazon Alexa. To this end, the two clouds interwork through a separate contract/agreement between the app manufacturer and the IoT device manufacturer.

The present disclosure is to solve several matters raised as problems in link control of IoT devices through the existing D2D (device-to-device), D2C (device-to-cloud), and C2C (cloud-to-cloud) connection methods described in FIG. 7.

In the case of the D2D, there is a point that the App and the device need to have the same technology/protocol in order to directly connect the App and the device. That is, in the case of the device, several technologies (Homekit, OCF) need to be implemented in the device in order to interwork with various types of heterogeneous apps. In addition, the biggest technical challenge of the D2D is that, when the App and the device are not located in the local network, remote access where the App controls the IoT controlee (device) from outside the house is not possible.

In the case of the D2C, both the controller and controlee are connected to the same cloud in order to solve the remote access, which is the disadvantage of D2D. However, this also has a technical task that several clouds need to be connected at the same time for a device to interwork with different manufacturers and technologies, or that different technologies (ThinQ, OCF, SmartThings) need to be implemented in one device for cloud connection.

In the case of C2C, it has more scalability than D2D or D2C in that it implements only one technology in the device, and implements connection from the cloud to multiple clouds to link with different technologies or different manufacturers. However, due to an inter-cloud link, a relatively large transmission delay occurs even in the control of devices close to a long transmission distance, and there is a technical problem in that cloud development/operation costs are incurred for a link through the cloud.

In the present disclosure, we propose a connection form of application-to-application (App2App) through the connection between the manufacturer's controller apps, and this is to solve remote access which is a disadvantage of device-to-device (D2D), heterogeneous expansion/link between which is a disadvantage of device-to-cloud (D2C), and cloud cost and long transmission delay which are disadvantages of cloud-to-cloud (C2C).

Although the embodiment of the present disclosure is described through connected home over IP (CHIP), the application or scope of the technology is not limited to the CHIP, and the embodiment of the present embodiment is applicable to all existing smart home/IoT technologies and general smart home/IoT environments.

The present disclosure describes how to enable an IoT link and service expansion between different manufacturers through a link with heterogeneous smart home/IoT controller applications. In the embodiment, the most general smart phone controller application will be described as an embodiment. However, the controller application is not limited to the application of a general smartphone, and includes all applications operated in non-smartphone devices such as artificial intelligence speakers, TVs, and wall pads.

2.1. Usage Scenarios and Examples

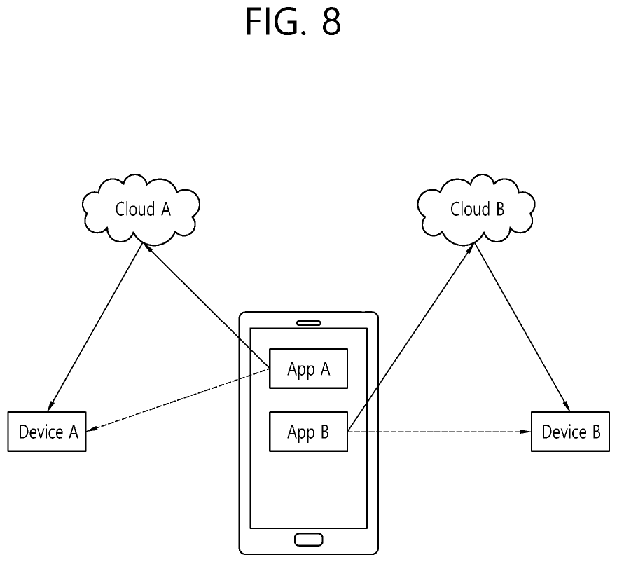

FIG. 8 is a diagram illustrating a conventional smart home/IoT connection structure.

In FIG. 8, “Application A” and “Application B” are installed on the user's smartphone. As in the related art, application A and application B operate independently, so that application A controls device A, and application B controls device B. This is a general conventional device-to-cloud connection type, in which devices and apps made by each manufacturer operate independently. Alternatively, it may be connected in the form of a device-to-device in which the app directly controls the device without the intervention of the cloud. Interworking between ecosystem A composed of App A, cloud A, and device A and ecosystem B composed of App B, cloud B, and device B is generally made through a link between cloud A and cloud B.

In order for App A to control device B (or App B to control device A), there are several methods (D2D, D2C, C2C) described above.

FIG. 8 is a form in which the user controls device A with App A and device B with App B, where App A-cloud A-device A may be called ecosystem A, and App B-cloud B-device B may be called Ecosystem B. For a link between ecosystems set in advance in this way, a link between devices is provided through a general cloud-to-cloud link. That is, App A may control device B and App B may control device A through the cloud API (application programming interface) that provides discovery and control between cloud A and cloud B.

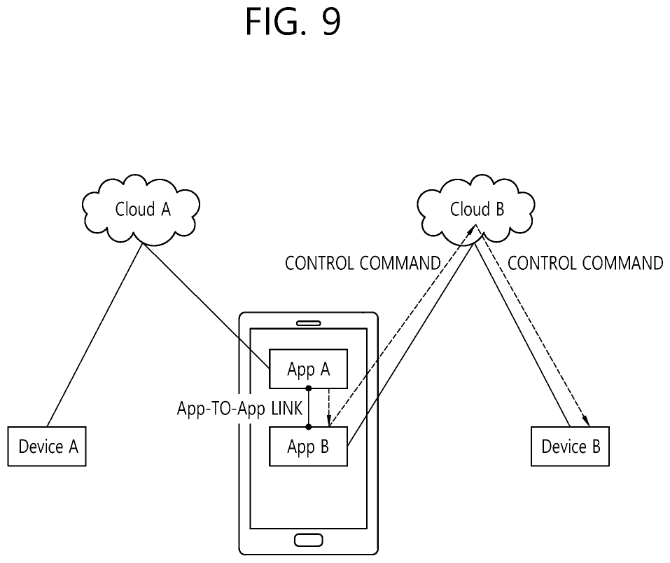

FIG. 9 is a diagram illustrating an example in which App A controls device B through App-to-App link.

The present disclosure describes an App-to-App method in which App A controls device B based on control/monitoring commands to App A-App B-cloud B-device B through a direct link with App B. In the embodiment of FIG. 9, App A and App B are expressed as apps that physically operate on one device, but it is not limited to a physical device and App A and App B may be extended to apps installed on other devices. Also, although App A is exemplified as an App-to-App connection for controlling device B, the App-to-App connection may be used for the method of controlling, by App B, device A, and may also be used to allow App B to control device A while App A controls device B.

App A and App B are not limited to controlling a simple device, and as in the following embodiment, may be used for a service link between Apps such asusing App B's service in App A, or performing App B's service according to the operation of App A's service.

2.2. Detailed Operation

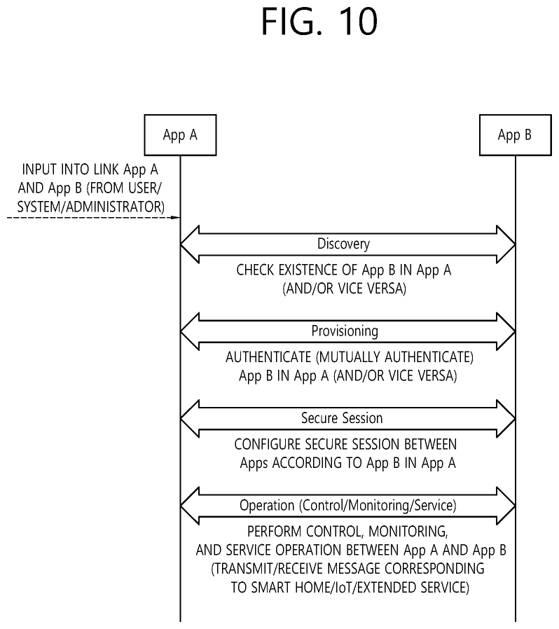

FIG. 10 is a diagram illustrating operation steps for App-to-App connection.

For App-to-App link, the following operation sequence is performed (see FIG. 10).

(1) Input—Input requesting to link App A with another App (App B).

i. Input by user through user interface (UI) or by remote input by administrator or input by system itself (e.g., automatic input when preset conditions such as routine are satisfied)

ii. Including input other than the above

(2) Discovery—App A checks the existence of App B

i. The detailed method of discovery will be described later.

(3) Provisioning—App A provisions App B and/or App B authenticates App A

i. The detailed method of provisioning between apps will be described later.

(4) Secure Session

i. Secure session setup for secure communication between two apps

ii. Details of the secure session between apps will be described later.

(5) Operation

i. Smart home/IoT device and status discovery through inter-app communication

ii. Smart home/IoT control and event reception through communication between two apps with operation status

iii. Extension service link

2.2.1. Discovery

The method of discovering between apps for an App-to-App link will be described. For an inter-app link, the user (or administrator) basically knows in advance the type or name of the app to be linked (ex, com.example.app_b), and checks the existence of the app through the discovery process.

The following embodiment is a process in which App A discovers for App B in one smartphone, and DNS-SD (Bonjour) is described for the embodiment. However, the scope covered by the present disclosure is not limited to one smartphone and includes the discovery protocol below without limiting the discovery method to DNS-SD of the embodiment.

Example of Discovery Protocol
DNS-SD (mDNS/Bonjour)-IP layer discovery protocol discussed in CHIP standard, broadcast to IP subnet through UDP (user datagram protocol) and receive response
UPnP (SSDP)-Used to discover other apps through multicast to IP subnet using SSDP, a discovery protocol used in UPnP
UDP Broadcasting—A method used in OCF D2D to broadcast to a specific UDP port and respond with unicast only to the corresponding device
Application installation table lookup—Check whether a specific app is installed in the list of installed applications in the OS
Cloud-to-Cloud—When there is a link between cloud A of App A and cloud B of App B. Query/Response method to check if the app is installed on the specific device of the user
Intent Broadcast—App A is a method of detecting the existence of an App through intent transmission, which is a communication method between apps provided by Android framework and iOS framework. A method in which App B (or App A) waits for the app name (ex com.lge.thingq) intent of a specific app to interwork with App2App through the filter, and responds by receiving the intent transmitted from the APP.

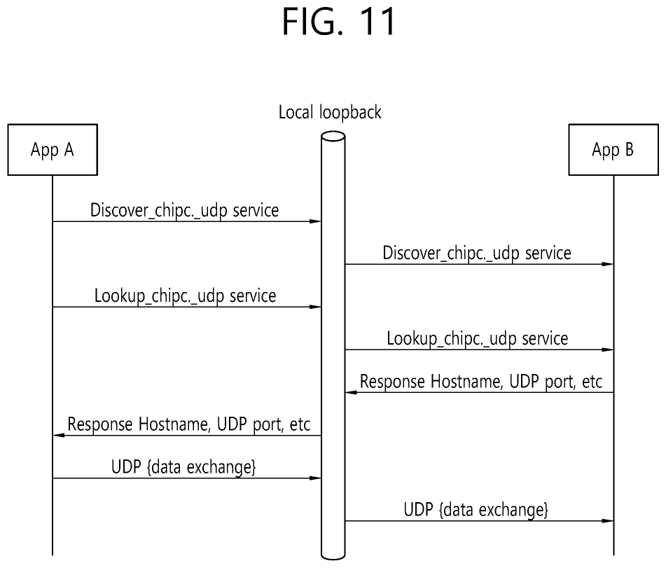

FIG. 11 is a diagram illustrating an App discovery method through local loopback.

FIG. 11 illustrates a method of confirming the existence between two apps installed in one smartphone using the Bonjour protocol. The Bonjour protocol is a protocol that operates on top of the IP protocol. For IP discovery within one physical device, local loopback (127.0.0.1) may be used to check the IP packet sent to itself. If App A and App B are installed on the same physical device, App A can find App B in the same way as in FIG. 11, and in the embodiment, the mDNS service is denoted as_chipc and the CHIP protocol is used as an embodiment, but the service name may be changed according to the definition of the App2App service. In the process, App B transmits information such as a specific UDP port and hostname (or App name) to App A, and the two APPs can communicate through a socket corresponding to a specific UDP port. Data transmitted through UDP may transmit information about App (manufacturer, version, capability, etc.) predefined information, and may be used for information exchange for authentication, which will be described later.

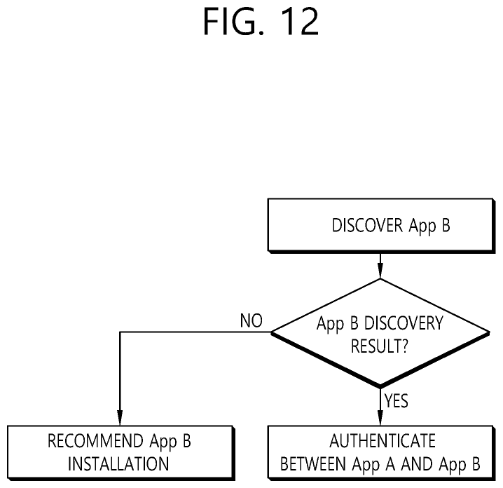

FIG. 12 is a diagram illustrating an operation when an App discovery fails.

When App A can not find App B, App A may recommend/recommend installation of

App B to the user in the following way. For example, when App A discovers for App B according to the above discovery method, but there is no response for a certain period of time, or when it is checked that the corresponding App is not installed in the App installation table, App A can induce the user (or administrator, system) to install App B.

2.2.2. Authentication

As in Section 2.2.1, when App A is discovered for App B according to a specific discovery method, App A performs one-way authentication of App B, or App A and App B perform mutual authentication in order to link App2App between two apps. The authentication process is carried out for two main purposes.

1) Check if the app is valid without hacking or security threats

2) Used for key distribution for secure session in App-to-App connection

As a method of authentication between two apps, the following methods are possible, and the present disclosure is not limited to a specific method, and may be extended to other authentication methods. In addition, multi-factor authentication using a combination of several authentication methods instead of applying only one authentication method is also possible.
OAuth2.0 authentication through a cloud account server link between App A and App B
Certificate-based authentication included in the app
App-to-app authentication through pre-shared key
Authentication based on information generated during authentication such as SMS,

PIN code, etc.
Authentication based on biometric information provided by devices such as smartphones (fingerprint, iris recognition, face recognition, etc.)

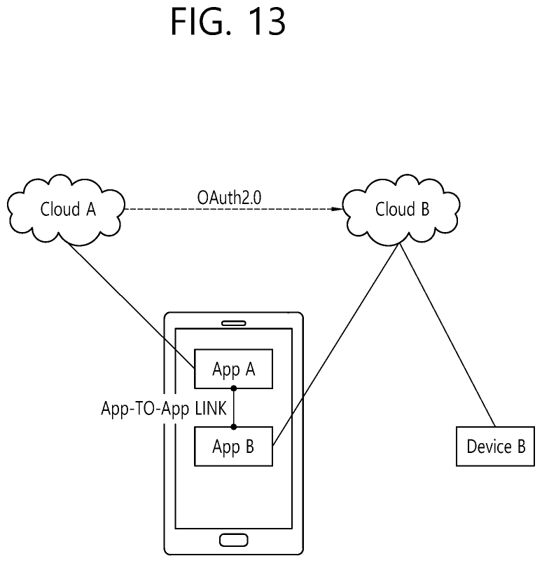

FIG. 13 is a diagram illustrating an overview of OAuth 2.0 authentication for App-to-App link.

FIG. 13 illustrates an embodiment of OAuth authentication through a cloud account, based on the assumption that App A and App B are connected to their respective clouds. Although FIG. 13 has been described as an example of OAuth2.0, it may be extended or applied to other OAuth2.0 applications.

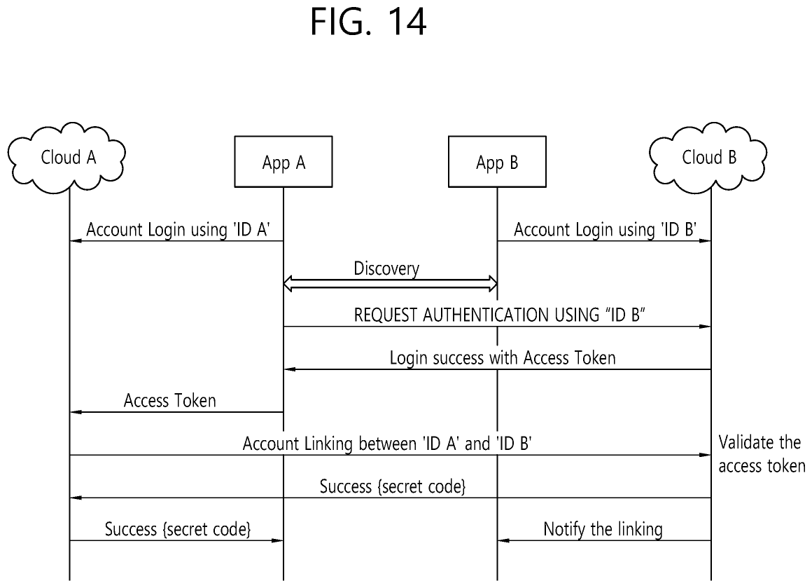

FIG. 14 is a diagram illustrating an OAuth 2.0 authentication operation for App-to-App link.

FIG. 14 is a view of an App authentication method of linking between apps through OAuth2.0.
First, App A is logged in through ID A to cloud A, which is the manufacturer's cloud. App B is the same status logged in to cloud B, the manufacturer's cloud, through ID B. This is the same as a general manufacturer cloud login, and cloud A and cloud B have their respective authentication servers. In addition, cloud A and cloud B have a cloud account link path to support OAuth2.0 in advance.
App A and App B are discovered as the existence of an App according to the App discovery method described in the previous section.
App A requests authentication for OAuth2.0 to cloud B, which is App B's cloud, in order to link with App B. In this case, App A enters ID and password of ID B to log in to cloud B.
When App A enters the ID and password appropriate for cloud B, App A receives a response and a token for success from cloud B.
App A requests an account link between ID A and ID B while transmitting the corresponding token to cloud A, which is its cloud.
Cloud A is an account of the same user, ID A, which is an account in its own account server, and ID B, which is an account in cloud B's account server, and transmits a request to link these two accounts together with a previously issued token to cloud B.
Cloud B authenticates that ID A and ID B are the same user through verification of the token received with the request. In this case, a secret code is issued to cloud A along with a success message.
Cloud A transmits the corresponding secret code to App A, and App A uses the code for subsequent secure session connection.
Cloud B also uses ID B registered in its account server, and notifies App B, which is App, that ID B's account is linked with ID A of cloud A. (When there are multiple apps logged in with ID B, it will also be transmitted to all other apps.)

The operation of FIG. 14 is an embodiment of account linkage through OAuth2.0, and other authentication methods may be extended. In addition, when App B mutually authenticates App A additionally, the same operation as the above process is performed in App B.

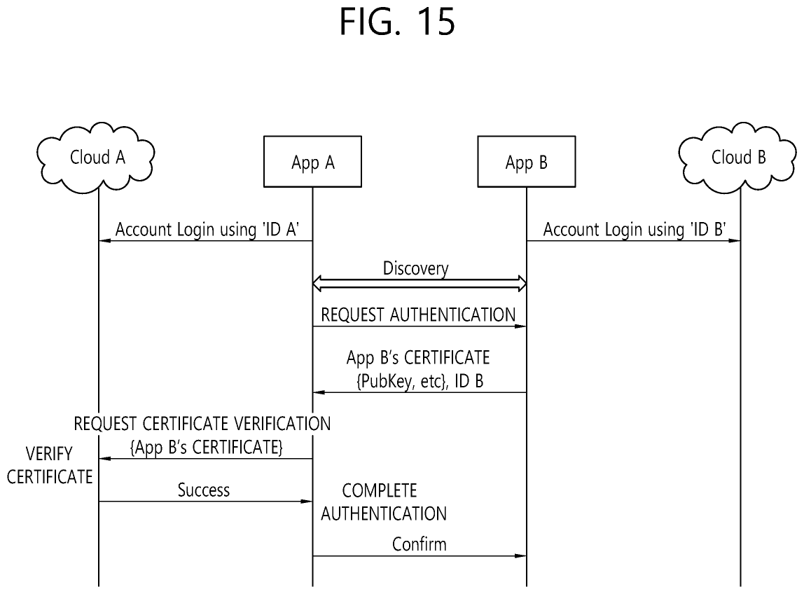

FIG. 15 is a diagram illustrating one-way authentication between certificate-based apps.
First of all, App A is the status of being logged in to cloud A, which is the manufacturer's cloud, through ID A. App B is the same status logged in to cloud B, the manufacturer's cloud, through ID B. This is the same as a general manufacturer cloud login, and cloud A and cloud B have their respective authentication servers. In addition, each cloud can verify a certificate issued (or signed) by the ecosystem or a certificate issued by a root CA such as ZigBee. Also, in the case of a certificate issued from another CA, certificate validation may be performed in the cloud by downloading the root public key of another CA.
App A discovers the existence of App B by the method described in Section 2.2.1.
App A makes a request for authentication to App B for authentication of App B. In this case, in the case of a channel through which App A and App B communicate, the UDP channel described in the previous section may be used.
App B will reply to App A's request with its own certificate and ID B, the account logged into cloud B. In this case, the form of the certificate may follow the form of X.509, and the object information included in the certificate is included in the certificate in the form of a vendor extension, or information (app version, manufacturer, etc.) related to IoT in addition to the public key is included in the certificate, or may be transmitted as separate parameter information.
App A requests verification of the received certificate from its own cloud, cloud A.
Cloud A verifies the corresponding certificate and informs App A of the result.
App A completes the authentication of App B based on the result, and App B is a valid App, and obtains information about the Public Key and ID B of the App.
App A notifies App B that authentication is complete through Confirmation.

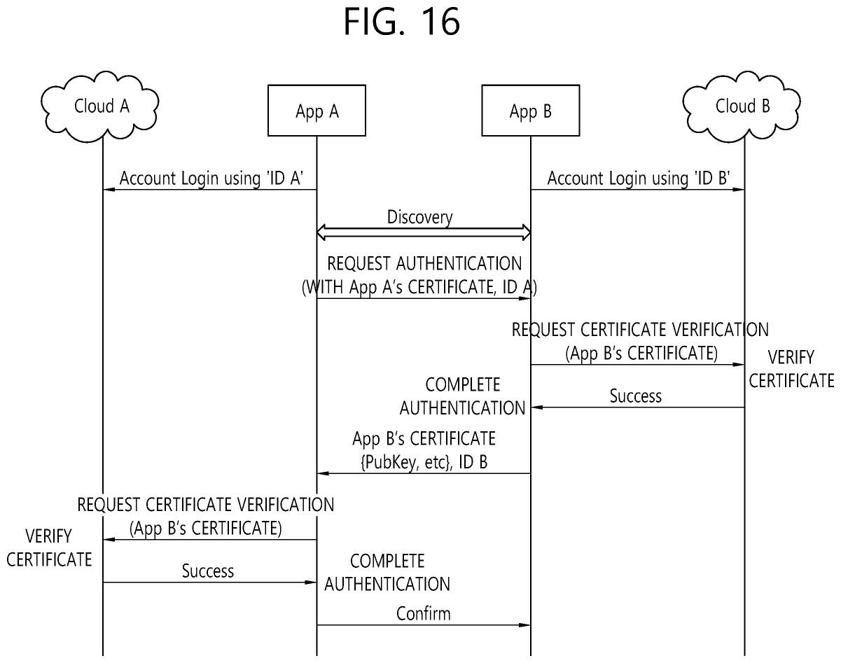

FIG. 16 is a diagram illustrating a mutual authentication operation of certificate-based App A and App B.

FIG. 16 illustrates a mutual authentication process for App A, App B, and App-to-App link.
First of all, App A is the status of being logged in to cloud A, which is the manufacturer's cloud, through ID A. App B is the same status logged in to cloud B, the manufacturer's cloud, through ID B. This is the same as a general manufacturer cloud login, and cloud A and cloud B have their respective authentication servers. In addition, each cloud can verify a certificate issued (or signed) by the ecosystem or a certificate issued by a root CA such as ZigBee. Also, in the case of a certificate issued from another CA, certificate validation may be performed in the cloud by downloading the root public key of another CA.
App A discovers the existence of App B by the method described in Section 2.2.1.
App A makes a request for authentication to App B for authentication of App B. In this case, in the case of a channel through which App A and App B communicate, the UDP channel described in the previous section may be used. When App A requests authentication, App A transmits its own certificate “App A's certificate” and information such as ID A in the request message. In this case, the public key information of App A is included in the certificate. In this case, the form of the certificate may follow the form of X.509, and the object information included in the certificate is included in the certificate in the form of a vendor extension, or information (app version, manufacturer, etc.) related to IoT in addition to the public key is included in the certificate, or may be transmitted as separate parameter information.
App B first performs App A's authentication for App A's request. App A's certificate and ID will be transmitted to your cloud, cloud B.
Cloud B verifies the corresponding certificate and informs App B of the result.
When App B is authenticated for App A, it will reply with its own certificate and ID B, which is the account logged into cloud B.
App A requests verification of the received certificate from its own cloud, cloud A.
Cloud A verifies the corresponding certificate and informs App A of the result.
App A completes the authentication of App B based on the result, App B being a valid App, and obtains information about the Public Key and ID B of the App.
App A notifies App B that authentication is complete through Confirmation.
Through this, the mutual authentication process in which App A authenticates App B and App B authenticates App A is completed.

The public key of each App verified as a result of authentication based on the certificate in FIGS. 15 and 16 is used for secure session setup, which will be described later.

2.2.3. Secure Session Connection

App A and App B connect the communication channel between apps to transmit and receive information such as control and monitoring for smart home/IoT. Communication between App A and App B needs to be secured through encryption. Even if the local loop is used within a single smartphone, there may be elements that other third-party apps monitor the channel or threaten security.

App A and App B authenticate each other through Section 2.2.2. authentication, and a secure code or public key may be used as a key to connect a secure session of Layer 4 (TCP/UDP). For the secure session between two apps, a TLS session may be established in the case of TCP communication and a DTLS security session may be established in the case of UDP communication. Even when communication other than TCP or UDP is used, the secure session may be established based on the secure key value generated in the authentication process described in the previous section.

In an embodiment, when App A and App B communicate using the CHIP protocol, a secure session such as SPAKE2+ defined in the CHIP standard may be established. In this case, the setup code (or device discriminator) can be derived based on the setup code or public key exchanged during the authentication process.

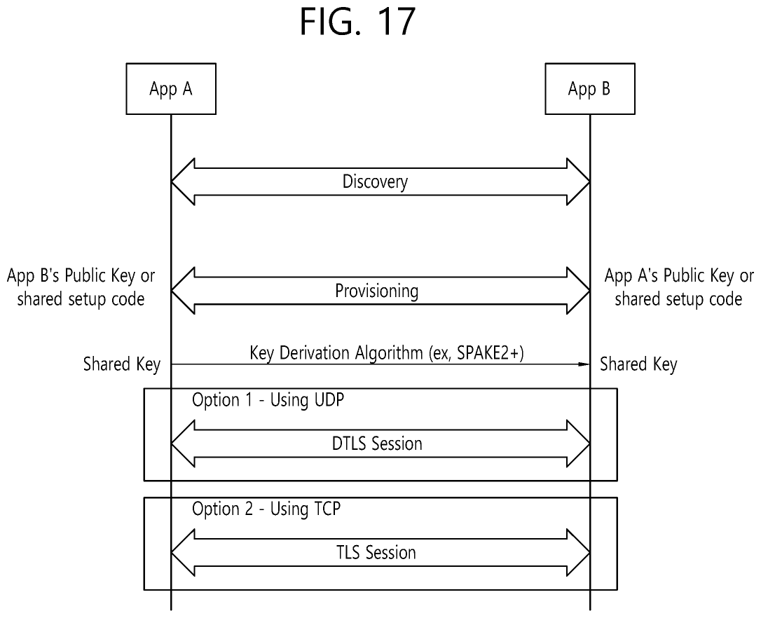

FIG. 17 is a diagram illustrating a secure session setup procedure for securing a communication channel between apps during App-to-App link.

FIG. 17 illustrates an embodiment of connecting a secure channel for security when App A and App B for an App-to-App link configure a communication channel App A and

App B can be used as a key to connect a secure session based on the public key (or setup code) shared with each other during the authentication process. Assume that two apps are physically installed on one smartphone. When App A and App B use UDP, two apps transmit UDP datagram through DTLS session for secure session of Local Loopback. If two apps communicate over TCP, the TCP payload is transmitted through a TLS session.

If the communication between the two apps does not use the local loopback of the IP protocol, the payload transmitted through DTLS or the key value created to establish TLS may be encrypted-decrypted.

The present disclosure does not limit the detailed encryption algorithm, but includes all contents applied by extending the encryption key value generated during the corresponding discovery and authentication process.

2.2.4. Device Discovery

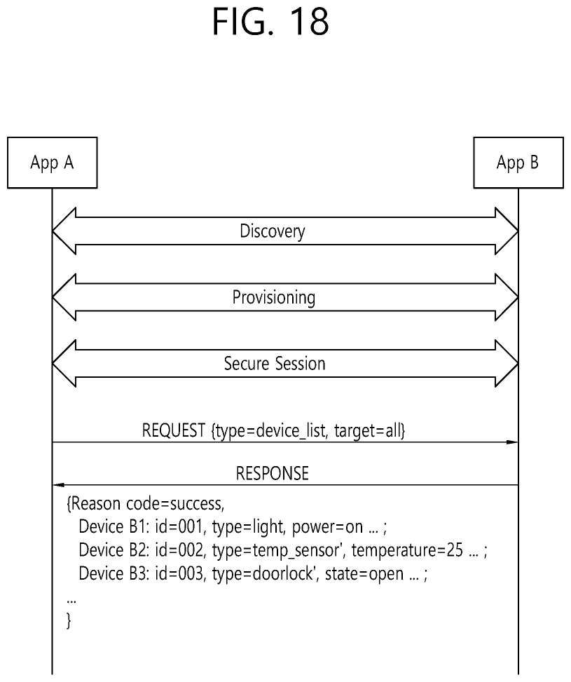

FIG. 18 is a diagram illustrating a device list discovery through App-to-App.

If the discovery, authentication, and encryption sessions between the two apps are completed, App A can discovery and check the device status through App B to control/monitor device B.

App A reads the list of devices previously connected to App B after connecting App B with App2App. App A makes a subscription request for the device list to App B, and App B transmits the entire (or part) list of devices connected to its App to App A. This device list may include status information of each device. The method of indicating the device list and status may borrow the form used in the general smart home/IoT environment. For example, in the case of the CHIP, the data model of ZigBee cluster library (ZCL) is used, and in the case of OCF, OCF data model (oneIota) may be used. In addition, a predefined data model and encoding method (JSON, CBOR, XML, etc.) can be used between separate apps. The present disclosure does not specify detailed definitions and encoding methods for the data model, and can be extended to other data models and encoding methods not mentioned in this embodiment.

FIG. 18 is a process in which App A checks a list and status of all devices connected to App B when App A and App B are linked. After App A and App B complete the discovery, authentication, and secure session process, App A makes a request to App B to transmit a list of devices. The processing of this request can be processed internally in App B or transmitted to a device such as cloud or hub connected to App B for processing.

When requesting the device list, App A transmits a request for the device list according to a predefined method and a request to include all information. After receiving the request, App B responds to App A with a list of connected devices. In this case, the present disclosure is not limited to the form and parameter of the message of the above embodiment, but is expandable.

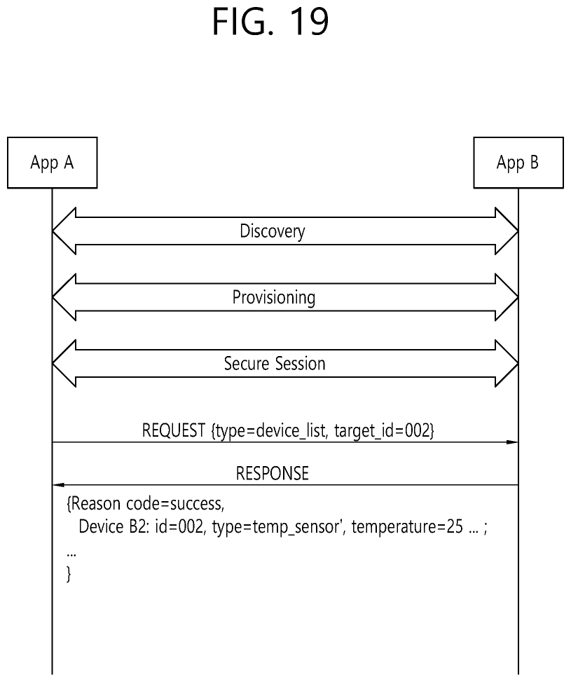

FIG. 19 is a diagram illustrating a status check of a specific device through App-to-App.

App A may request the status of a specific single device from App B. This is possible through a request through an identifier of a specific device as illustrated in FIG. 13 below. When requesting the device status, App A transmits the request including the type of requested the device list according to a predefined method and the identifier of a specific device. After receiving the request, App B responds to App A with the status of a specific connected device. In this case, the present disclosure is not limited to the form and parameters of the message of the embodiment, but is expandable.

2.2.5. Device Control (Control/Monitoring)

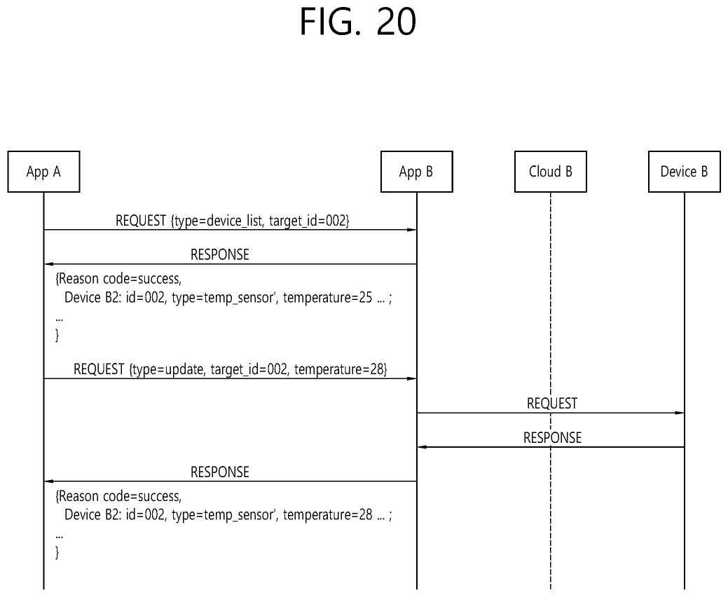

FIG. 20 is a diagram illustrating an example in which App A controls a device connected to App B.

After checking the status of the device through App-to-App, App A enters the operation stage where it can be controlled and monitored through App B. Originally, both App A and App B are smart home/IoT controller applications, but in this embodiment, App A serves as a controller (controller/client) to bring and control a list of devices connected to App B (ex. device B), and App B is a controlee (controlee/server) role that provides device B that App A may control.

The control operation is in the form of requesting a control command from App A as illustrated in FIG. 20, and processing and responding to the control command from App B. Initial App A checks the status to know the status of device B (optional). In this case, in order for App B receiving the status check request to respond to the device status, a method in which the App B performs 1) response with device status information cached in App B itself, or checks the actual status of device B at the time of the status check request and performs a response is possible. After checking the status, App A performs a control command (update) to change status to App B. In this case, the command for changing the status should be transmitted to the actual device B to change the status of the device, and these methods will be described later. In the embodiment, App A checks the device status of device B connected to App B. Now that the current temperature is 25° C., App A generates a command to change the current temperature to 28° C. and transmits the command to App B. App B executes this control command to device B to enable temperature control of the actual device.

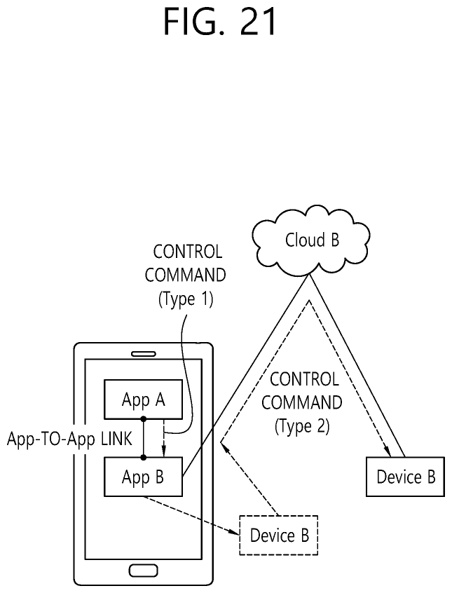

The transmission of the control command from App B to device B is possible in the method illustrated in FIG. 21.

FIG. 21 is a diagram illustrating an example in which App A transmits a command to a device connected to App B.

FIG. 21 illustrates a structure for transmitting a command transmitted from App A (controller) to device B. In the following embodiment, a command received from App A is received by device B virtualized in App B, and a control command for App-to-App between App A and App B uses a specific type (Type 1), and App B and cloud B-device receiving the control command use Type 2, another control command form. For example, a method in which communication between App A (Google Home) and App B (LG ThinQ) uses the CHIP protocol, and LG's ThinQ platform and protocol is used between App B (LG ThinQ) and cloud (ThinQ cloud) and between cloud B and device B (LG home appliance).

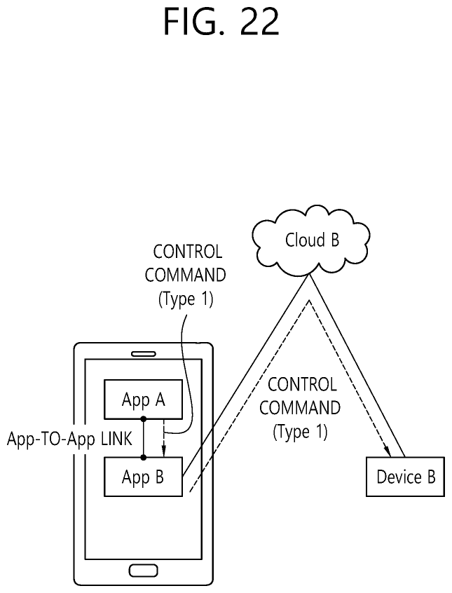

FIG. 22 is a diagram illustrating another example in which App A transmits a command to a device connected to App B.

Unlike FIG. 21, FIG. 22 is a case in which a transmission protocol/technology between App A and App B and a command transmitted between App B-cloud B-device B use the same protocol/technology. In this case, it is possible to transmit the command from App B to device B without converting the control command (Type 1->Type 2).

2.2.6. Receive Notification from Device

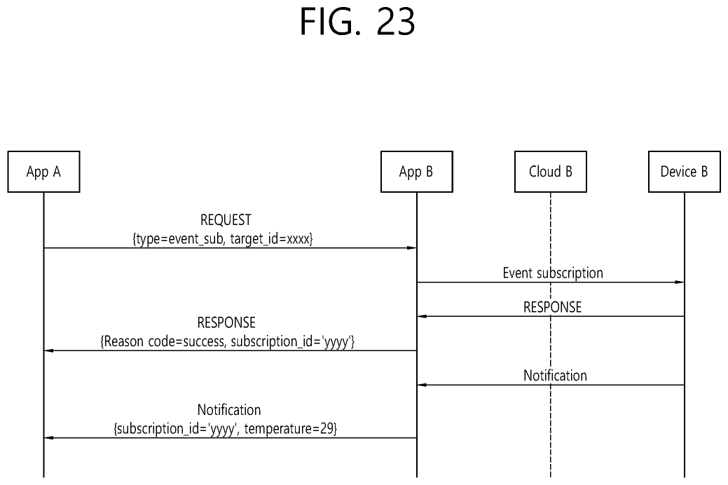

FIG. 23 is a diagram illustrating an event reception setting and event reception process in an App-to-App connection.

In the App-to-App link, it is possible to receive a notification about a specific status change from the device. This is a common scenario when the device status changes and a sensed event are received by the App, and the same operation can be performed in the App-to-App connection. In order to receive event/notification from App-to-App, an operation as shown in FIG. 23 is performed between App A and App B.

2.3. App-to-App Link Using Connected Home Over IP (CHIP)

As an embodiment of the present disclosure, when App A and App B support CHIP, an embodiment of an App-to-App link through CHIP will be described. As described in the previous section, in the App-to-App link, each App may play a controller role or a controlee role. Alternatively, the controller role and the controlee role for the App-to-App link of one App may be simultaneously performed.

When using the CHIP in the App-to-App connection described as an embodiment in this section, the App plays the role of the CHIP commissioner (controller) or the CHIP accessory (device) according to the CHIP standard.

2.4. App-to-App Link Between Multiple Apps

In the case of the App-to-App link described in the previous section, for convenience of explanation and understanding, it was explained as 1:1 interworking between apps. When three or more apps exist, the App-to-App link may be extended to App-to-multiple Apps, multiple Apps-to-App, or multiple Apps-to-multiple Apps.

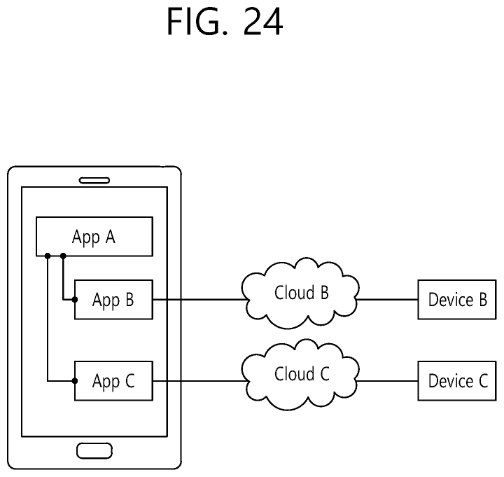

FIG. 24 is a diagram illustrating an example of multi-App and App-to-App links.

FIG. 24 is an embodiment in which App A (controller role) performs interworking with different App B (controlee) and App C (controlee). App A discovers multiple apps in the discovery process, and connects App B and App C at the same time by performing authentication and security sessions, respectively.

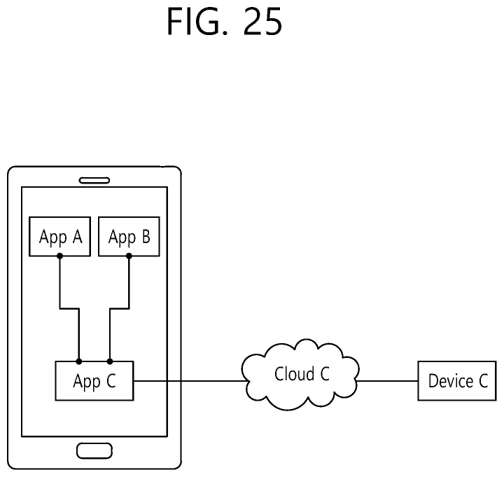

FIG. 25 is a diagram illustrating an example in which device C is controlled from multiple apps.

FIG. 25 illustrates that, when both the App A and App B serve as controllers, App C may process different control commands through two different App and App-to-App links.

When multiple apps exist through the combination of FIGS. 24 and 25, a mesh-type

App-to-App link is possible according to the interworking between the apps.

In the present disclosure, the configuration and design of the topology of the App-to-App link are not limited to 1:1 or n:1 or 1:n, and the structure of the topology and the connection of the App link are expandable.

2.5. Service Link

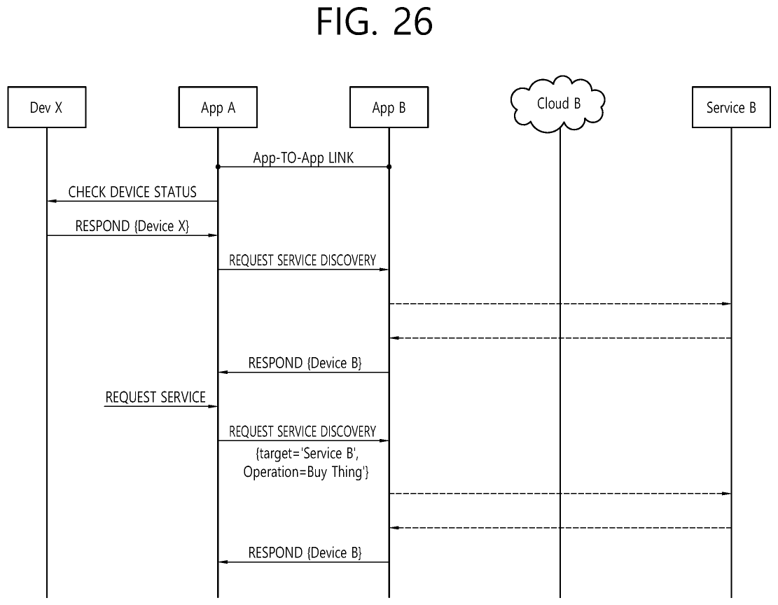

FIG. 26 is a diagram illustrating a method of performing a service through App-to-App link.

The App-to-App link may be extended and applied not only to device discovery and control, but also to service interworking between App A and App B. This defines the service supported by each App in the same way as a device in App-to-App device control, so the App A may perform App B service.

App A is the controller role, and App B is the controlee (service provider) role. Service B is connected to App B, and App A and App B may be linked with services through the above method of interworking in App-to-App. App A may discover an App that App B exists in a similar way to the IoT device control proposed above, and authentication between apps can be performed through the authentication process. A secure channel is established between apps to discover devices or services. The service discovery is the same as the device discovery. App B responds to a request from App A and a service associated with it (or internal). App A may check the service of App B and perform the service of App B through the communication channel between apps.

In an embodiment, App A is a role of an aggregator App in charge of control, and App B may have Service B. App A connects device X, and in the case of device X, and includes all devices linked to App. That is, device X may be a device belonging to ecosystem A of App A, a device belonging to ecosystem B of App B, or a device of a third-party manufacturer.

For example, service B may be an Internet shopping mall service for ordering products online. If device X is a washing machine device, service B may be a service for ordering laundry detergent required for the washing machine. App A may know that the detergent of the washing machine is insufficient through the App-to-App link, and may request a detergent order service from service B (see FIG. 26).

4.6. UX and SW Structure for App-to-App

This section will be described based on the embodiment of the UX and SW structure for controlling the device through the App-to-App connection.

In the past, for communication between apps (processes), data could be exchanged between apps (processes) through Intent in Android and DBUS and IPC in Binder Linux, but Intents can receive data from any app, so they are not suitable for passing sensitive data. IPC series such as DBus and Binder had high complexity to implement because the generated interface code had to be added to both codes.

The present disclosure provides an ATA (App-to-App) interworking support module to facilitate and secure communication between apps using loopback to facilitate data transmission between apps.

The functions provided by the ATA interworking support module are as follows.

(1) Support communication between apps based on Loopback

(2) Support for secure connection between apps (app authentication)

(3) Manage callbacks to process notifications between apps

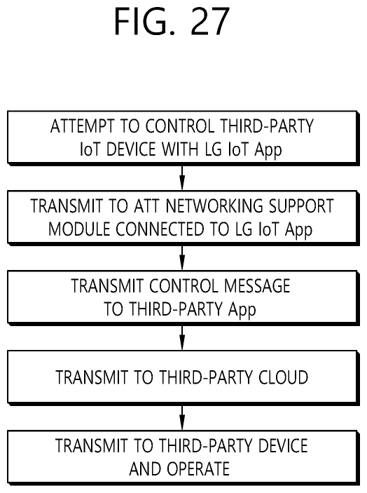

FIG. 27 is a flowchart of controlling a third-party device with the LG IoT App through an ATA interworking support module.

First, the controller attempts to control other companies' IoT devices through the ATA interworking support module connected to the LG IoT App with the LG IoT App. In this case, the control message may be transmitted and operated in the order of a third-party app, a third-party cloud, and a third-party device.

4.6.1. Support Communication between Apps based on Loopback

This solution proposes communication between apps using a virtual loopback interface using IP to enhance security and implementation convenience in App to App communication.

The virtual loopback interface using IP has the following structure.

The loopback address between A and B can be configured as follows, and can be defined as IPv4 (127.0.0.1) or Ipv6 (::1) or localhost as the IP address and port number.

Ex)

localhost:<port number>

127.0.0.1: <port number>

The port number may be defined by promising the port number between the apps to be linked, or set as a random port and find the port number with a service such as mDNS or Bonjour. The port number range should be defined as the private or ephemeral ports (49152 to 65535) as much as possible except for well known ports (0 to 1023)/registered ports (1024 to 49151) defined in RFC6335.

For example, when App A and App B communicate on the same device, the port number is defined as follows for the address and port address.

App A: localhost:49153

App B: localhost:65534

When App A and App B are on different devices

App A: 192.168.0.101:49153

App B: 192.168.0.102:65534

In order to control Apps A and B, a secure session should be preceded.

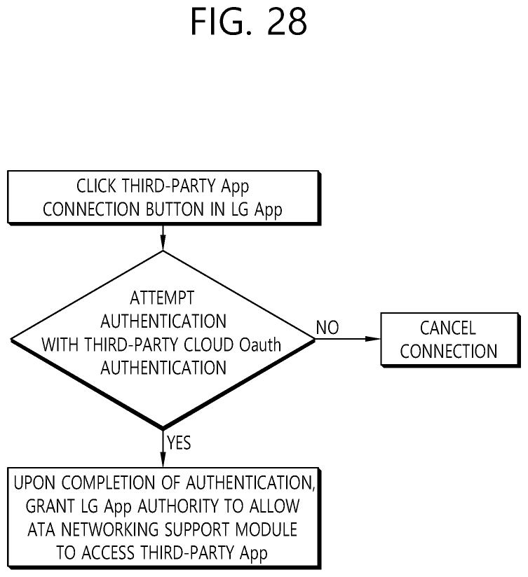

FIG. 28 is a flowchart illustrating an LG App connection with a third-party App.

When the “Connect to Third-Party IoT App” button is clicked in App A, it is checked if the already defined port is open or use mDNS/Bonjour to find an App that supports A2A.

When the App is found, a pop-up window shows B, which is a connectable App, in the form of a list, and the user checks the B and then connects the B.

If company B is selected, OAuth-based login is performed to authenticate the use authority of company B.

When logging in normally with OAuth, a certificate-based, asymmetric key encryption, or symmetric key is selected to encrypt data between apps and stored in each app. The encryption method or scheme is not specifically specified in the present disclosure. When the encryption key is exchanged between apps, all data is encrypted/decrypted when transmitting data.

When the encryption key is exchanged, the secure channel creation is completed and the LG App <-> A company's App is connected.

When the connection is completed, device information is retrieved by discovering the device of company A in the LG App with the ATA discovery command.

4.6.2. Device Control

App A controls the device of App B company.

It is checked if the device that clicked App B in App A is an ATA device.

For transmission from App A to ATA App B, it is transmitted to the ATA interworking support module operated based on network loopback.

Control data is transmitted from an ATA interworking support module to B.

The control data transmitted to B is transmitted to the cloud of company B.

Data transmitted to company B's cloud is transmitted to company B's device and operated.

4.6.3. Device Notification

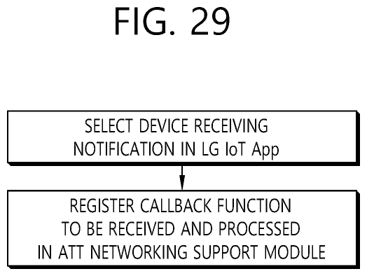

FIG. 29 is a diagram illustrating a flowchart of a device notification.

Devices receiving notifications are selected.

A callback to handle notifications is stored in the ATA interworking support module.

When a notification comes from a third party, the callback registered in the ATA interworking support module is called and App A handles it.

In the flowchart below, “LG IoT App” may act as App A, and third-party apps may act as App B. Conversely, a third-party app may play the role of App A, and the LG IoT App may play the role of App B.

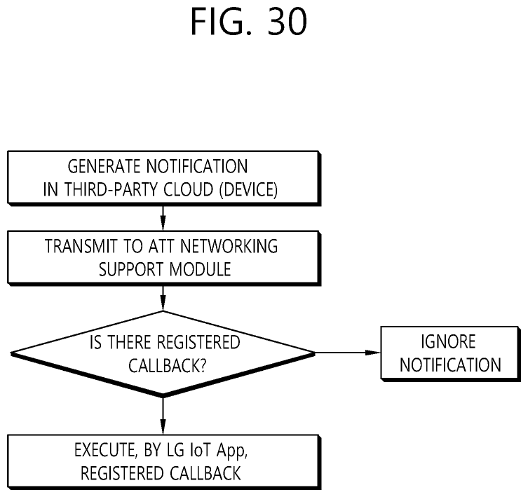

FIG. 30 is a flowchart of registering a callback for the device notification.

Referring to FIG. 30, in order to process device notifications, a callback of an device of interest is registered in the ATT networking support module. When a notification is generated from a third-party cloud (device), it is first transmitted to the ATT networking support module. When there is a registered callback of the device, the device is executed to transmit a notification to the app.

Hereinafter, the above-described embodiment will be described with reference to FIGS. 1 to 30.

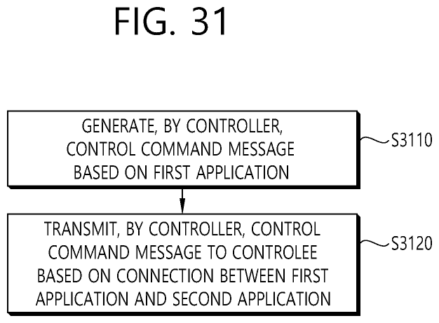

FIG. 31 is a flowchart illustrating a procedure for linking and controlling IoT devices based on App to App communication according to the present embodiment.

The present embodiment provides a method of linking and controlling, by an IoT controller, IoT devices through a connection between apps in a smart home environment. A controller to be described later may correspond to the IoT controller, and a controlee may correspond to the IoT device. The first and second applications to be described later may correspond to applications (Apps) of the same or different manufacturers installed in the controller.

In step S3110, the controller generates a control command message based on the first application.

In step S3120, the controller transmits the control command message to a controlee based on the connection between the first application and the second application.

The first and second applications are installed on the controller. The controlee is controlled by the second application. For example, it is assumed that the first application is made by manufacturer A and may control the device of the manufacturer A, and the second application is made by manufacturer B and may control the device of the manufacturer B. In this case, when the controlee corresponds to the device of the manufacturer B, the controller may interwork the first and second applications so that the first application may control the controlee. That is, the present embodiment provides an application-to-application between each manufacturer's apps to solve remote access which is a disadvantage of device-to-device (D2D), heterogeneous expansion/link between which is a disadvantage of device-to-cloud (D2C), and cloud cost and long transmission delay which are disadvantages of cloud-to-cloud (C2C).

Although this embodiment assumes that the first and second applications are installed on one physical device (the controller), the present embodiment is not limited thereto, and the first application may be installed on the first controller, and the second application may be installed on the second controller.

In addition, the present embodiment is not limited to controlling the controlee through connection (link) between the first and second applications, and may provide a method of using the service of the second application in the first application or a method in which the first and second applications are used for service interworking between apps as the service of the second application is performed according to the service operation of the first application.

The controlee may be connected to the second application through one local network or is connected to the second application based on a cloud.

The link between applications may proceed in the following order of operation. First, an input step for the first application to request interworking with the second application is performed. Second, a discovery step for the first application to check the existence of the second application is performed. Third, an authentication step in which the first application performs one-way authentication (or mutual authentication) of the second application is performed. Fourth, a secure session step in which a secure session for secure communication is established between the first and second applications is performed. Fifth, an operation step of discovering an IoT device and status through communication between the first and second applications and controlling the IoT device or receiving an event is performed.

The discovery step is specifically performed as follows. The first and second applications may discover each other based on a Bonjour protocol. The first and second applications may perform an Internet protocol (IP) discovery based on a local loopback in the controller, and. The first and second applications may exchange data through user datagram protocol (UDP). When the first application may not discover the second application, the first application may recommend or induce the user to install the second application.

The authentication step is specifically performed as follows. The first and second applications may be authenticated (OAuth2.0 authentication) based on cloud account linkage, authenticated based on the certificates included in the first and second applications, authenticated based on a pre-shared key, authenticated based on information generated during the authentication, or authenticated based on biometric information provided by the controller.

The secure session step is specifically performed as follows. When the first and second applications are authenticated, a public key or a setup code may be generated by the first and second applications. The secure channel may be established between the first and second applications based on the public key or the setup code, and the first and second applications may be connected based on the secure channel

The operation step is specifically performed as follows. The controller may transmit a status check request message to the controlee based on the connection between the first and second applications. The controller may receive a first response message to the status check request message from the controlee based on the connection between the first and second applications. The controller may check the status of the controlee based on the first response message. The status of the controlee may be an on/off status of a light bulb when the controlee is a light bulb, a temperature indicated by a temperature sensor when the controlee is a temperature sensor, and may be whether the door lock is opened/closed when the controlee is a door lock.

In this case, the control command message may be transmitted to change the status of the controlee. The controller may receive a second response message to the control command message from the controlee based on the connection between the first and second applications. The controller may check the changed status of the controlee based on the second response message.

The control command message may be transmitted from the second application to the controlee through the one local network or the cloud. The second response message may be transmitted from the controlee to the second application through the one local network or the cloud. That is, the control command message and the second response message transmitted or received through a connection (interworking) between the first and second applications may be transmitted between the second application and the controlee.

The controller may transmit an event subscription message to the controlee based on the connection between the first and second applications. The controller may receive a first response message to the event subscription message from the controlee based on the connection between the first and second applications. The controller may receive an event notification message from the controlee based on the connection between the first and second applications when an event occurs in the controlee.

The first and second applications may be connected or linked through the connected home over IP (CHIP). According to the CHIP standard, the first and second applications may serve as a CHIP commissioner (Controller) or a CHIP accessory (device). In addition, not only a 1:1 link of the first and second applications, but also interworking extension with a separate application (a third application) may be possible.

In addition, the service discovery/service execution may be requested based on the connection between the first and second applications, and a response message may be received through this to perform a specific service through the connection of the first and second applications.

3. Device Configuration

The technical features of the present disclosure described above may be applied to various devices and methods. For example, the technical features of the present disclosure described above may be performed/supported through the apparatus of FIGS. 1 and/or 6. For example, the technical features of the present disclosure described above may be applied only to a part of FIGS. 1 and/or 6. For example, the technical features of the present disclosure described above are implemented based on the processing chips 114 and 124 of FIG. 1, implemented based on the processors 111 and 121 and the memories 112 and 122 of FIG. 1, or implemented based on the processor 610 and the memory 620 of FIG. 6. For example, the device of the present disclosure is a device operating in a wireless LAN system of a smart home environment, and the device includes a memory and a processor operatively coupled to the memory, in which the processor generates a control command message based on a first application, and transmits the control command message to a controlee (controlee) based on the connection between the first application and the second application.

The technical features of the present disclosure may be implemented based on a CRM (computer readable medium). For example, CRM proposed by the present disclosure is at least one computer readable medium including instructions based on being executed by at least one processor.

The CRM may store instructions to perform steps of generating a control command message based on the first application, and transmit the control command message to a controlee (controlee) based on the connection between the first application and the second application. The instructions stored in the CRM of the present disclosure may be executed by at least one processor. At least one processor related to CRM of the present disclosure may be the processors 111 and 121 or the processing chips 114 and 124 of FIG. 1, or the processor 610 of FIG. 6. Meanwhile, the CRM of the present disclosure may be the memories 112 and 122 of FIG. 1, the memory 620 of FIG. 6, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input into the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically processes or operates a given task with own ability thereof. In particular, a robot having a function of recognizing an environment and autonomously making a judgment to perform an operation may be referred to as an intelligent robot.

Robots may be classified into industrial, medical, household, military robots and the like according to uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

According to the embodiment provided in the present disclosure, since each manufacturer's application-to-application connection is provided to link and control IoT devices, it is possible to solve remote access which is a disadvantage of device-to-device (D2D), heterogeneous expansion/link between which is a disadvantage of device-to-cloud (D2C), and cloud cost and long transmission delay which are disadvantages of cloud-to-cloud (C2C).

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

What is claimed is:

1. A wireless LAN system in a smart home environment, comprising:
generating, by a controller, a control command message based on a first application; and
transmitting, by the controller, the control command message to a controlee based on a connection between the first application and the second application,
wherein the first and second applications are installed on the controller, and
the controlee is controlled by the second application.

2. The method of claim 1, wherein the controlee is connected to the second application through one local network or is connected to the second application based on a cloud.

3. The method of claim 2, further comprising:
transmitting, by the controller, a status check request message to the controlee based on the connection between the first and second applications;
receiving, by the controller, a first response message to the status check request message from the controlee based on the connection between the first and second applications; and
checking, by the controller, the status of the controlee based on the first response message,
wherein the control command message is transmitted to change the status of the controlee.

4. The method of claim 3, further comprising:
receiving, by the controller, a second response message to the control command message from the controlee based on the connection between the first and second applications; and
checking, by the controller, the changed status of the controlee based on the second response message.

5. The method of claim 4, wherein the control command message is transmitted from the second application to the controlee through the one local network or the cloud, and
the second response message is transmitted from the controlee to the second application through the one local network or the cloud.

6. The method of claim 1, wherein the first and second applications discover each other based on Bonjour protocol,
the first and second applications perform an Internet protocol (IP) discovery based on a local loopback in the controller, and
the first and second applications exchange data through user datagram protocol (UDP).

7. The method of claim 6, wherein the first and second applications are authenticated based on cloud account link, authenticated based on the certificates included in the first and second applications, authenticated based on a pre-shared key, authenticated based on information generated during the authentication, or authenticated based on biometric information provided by the controller.

8. The method of claim 7, wherein when the first and second applications are authenticated, a public key or a setup code is generated by the first and second applications,
a secure channel is established between the first and second applications based on the public key or the setup code, and
the first and second applications are connected based on the secure channel.

9. The method of claim 1, further comprising:
transmitting, by the controller, an event subscription message to the controlee based on the connection between the first and second applications;
receiving, by the controller, a third response message to the event subscription message from the controlee based on the connection between the first and second applications; and
receiving, by the controller, an event notification message from the controlee based on the connection between the first and second applications when an event occurs in the controlee.

10. A controller in a wireless LAN system in a smart home environment, comprising:
a memory;
a transceiver; and
a processor operably coupled to the memory and the transceiver,
wherein the processor is configured to:
generate a control command message based on a first application, and
transmit the control command message to a controlee based on a connection between the first application and a second application, and
the first and second applications are installed on the controller, and
the controlee is controlled by the second application.

11. The controller of claim 10, wherein the controlee is connected to the second application through one local network or is connected to the second application based on a cloud.

12. The controller of claim 11, wherein the processor transmits a status check request message to the controlee based on the connection between the first and second applications,
receives a first response message to the status check request message from the controlee based on the connection between the first and second applications, and
checks the status of the controlee based on the first response message, and
the control command message is transmitted to change the status of the controlee.

13. The controller of claim 12, wherein the processor receives a second response message to the control command message from the controlee based on the connection between the first and second applications, and
checks the changed status of the controlee based on the second response message.

14. The controller of claim 13, wherein the control command message is transmitted from the second application to the controlee through the one local network or the cloud, and
the second response message is transmitted from the controlee to the second application through the one local network or the cloud.

15. The controller of claim 10, wherein the first and second applications discover each other based on Bonjour protocol,
the first and second applications perform an Internet protocol (IP) discovery based on a local loopback in the controller, and.
the first and second applications exchange data through user datagram protocol (UDP).

16. The controller of claim 15, wherein the first and second applications are authenticated based on cloud account link, authenticated based on the certificates included in the first and second applications, authenticated based on a pre-shared key, authenticated based on information generated during the authentication, or authenticated based on biometric information provided by the controller.

17. The controller of claim 16, wherein when the first and second applications are authenticated, a public key or a setup code is generated by the first and second applications,
a secure channel is established between the first and second applications based on the public key or the setup code, and
the first and second applications are connected based on the secure channel.

18. The controller of claim 10, wherein the processor transmits an event subscription message to the controlee based on the connection between the first and second applications,
receives a third response message to the event subscription message from the controlee based on the connection between the first and second applications, and
receives an event notification message from the controlee based on the connection between the first and second applications when an event occurs in the controlee.

19. At least one computer readable medium including an instruction based on the following steps executed by at least one processor:
generating a control command message based on a first application, and
transmitting the control command message to a controlee based on a connection between the first application and a second application,
wherein the first and second applications are installed on the controller, and
the controlee is controlled by the second application.
